(19) United States
(12) Patent Application Publication
(10) Pub. No.: US 2017/0004806 A1
(43) Pub. Date: Jan. 5, 2017

(54) Method and apparatus to enable smartphones and computer tablet devices to communicate with interactive devices

(71) Applicant: Thomas Joseph Edwards, Bangor (GB)

(72) Inventor: Thomas Joseph Edwards, Bangor (GB)

(21) Appl. No.: 15/187,805

(22) Filed: Jun. 21, 2016

(30) Foreign Application Priority Data
Jul. 1, 2015 (GB) GB1511582.7

(51) Int. Cl. G09G 5/12; G06F 3/03; G09G 5/00; H04B 1/3827; H04Q 11/00; A63F 13/327; H04W 76/02; A63F 13/92; A63F 13/34; A63F 13/25; A63F 13/213; G06F 3/14; H04L 29/12

(52) U.S. Cl. CPC G09G 5/12; G06F 3/1423; G06F 3/0325; G09G 5/006; H04B 1/3833; H04Q 11/0003; H04L 61/2007; H04W 76/02; A63F 13/92; A63F 13/34; A63F 13/25; A63F 13/213; A63F 13/327; G09G 2370/18

(57) ABSTRACT

A method and apparatus to enable smartphones and computer tablet devices to communicate with interactive devices, using a selected area of the emissive display of the smart device coupled to one or more optical guides 1. Additionally the enabled optical communication allows smart devices to indicate their position, identity and orientation 3 relative to a receiving device. The enabled optical communication further allows a smart device to communicate with simple electromechanical structures 11 which are adapted to receive, resolve and transmit such compatible optical data. The enabled smart device may further permit additional user input means wherein selected areas of the emissive display of the smart device are redirected by optical structures which may be switchable by deflection of the light guide or a physical interruption 12 of the optical signal along the path to and prior to detection by the same smart device's photodetector or camera.

### BACKGROUND TO THE INVENTION

The instant invention relates to an apparatus and method which provide smart devices with an additional means of optically generated communication providing functionality generally not available to smart devices such as computer tablets and smartphones.

This invention relates in general, but not exclusively, to a method and apparatus to enable a modern mobile personal smart device, such as a computer tablet, a smartphone or a media player to communicate data to and to optionally control and to optionally receive feedback from at least one another device or structure. Furthermore, the invention relates to a method, apparatus and system for converting smartphones, computer tablets, video players or the like, each equipped with a processor and with an optically emissive display screen and optionally a photodetector, for example a camera, into interactive devices capable of indicating their own positions relative to another device and further resolving the relative positions of similarly enabled devices wherein data between devices may be selectively communicated and may be based on the contextual relevance of that data to the interacting devices. The invention also enables smart devices with an auxiliary means of user input in the form of optical switch elements or arrays which may be positioned on or about the smart devices as the application requires.

### SUMMARY OF THE PRIOR ART

In U.S. Pat. No. 8,246,467 B2 a games system is generally described which utilises a processor, sensors and communication hardware normally found on smartphones. The gaming system described uses each device's GPS to determine its own relative position, with each gaming device being independent and typically belonging to an individual game player. The remote positions of each game player device are then communicated wirelessly to the other game devices and devices are then mapped virtually onto the display of the local smartphone. Interactions between the virtual players are then enacted on respective displays of each of the player's devices. This arrangement is therefore a means of representing the relative positions of remote players on a smartphone device display to allow participation in gameplay, generally using each individual device's on-board GPS to realise the absolute positioning of each game player (i.e. device). By using resident sensors to determine each device's own orientation, such sensor derived information is communicated to each other participating device to allow each device to determine its own position relative with respect to the other devices in the established network.

In EP 1899939 the underlying configuration and functional operation of manually manipulable interactive devices is described. Particularly, a processor-controlled block or tile has the ability to communicate “characterization” information to similar devices that are detected and assessed to be positioned within a meaningful range. Based on the instantaneous characterization, a sensory response (typically in the form of sound or visual output) is generated by one or more of the blocks either in unison or in sequence, with the sensory response generally dependent upon realization of a meaningful interaction between currently presented characterizations on each of the interacting blocks or tiles. Moreover, based on relative positions between the blocks or tiles and a determination that a meaningful combination of characterizations has occurred, one or more of the blocks may dynamically and automatically take on a new characterization, expression or appearance and thus present a new sensory output. The blocks are therefore arranged to communicate data to each other, e.g. over a wireless link.

In EP 1899939 each changeable individual characterization may comprise visual display material (such as a static or animated image) or audio output material or both, which individual characterization will vary depending on the particular application or purpose of the device or devices. For example, visual display material may comprise a letter or group of letters (e.g. phoneme) or word or words, and the sensory response may comprise speech corresponding to a word or phrase or sentence spelt out by the letters or words. In another application, visual display material may comprise a number or mathematical symbol, and the sensory response may comprise speech relating to mathematical properties of the numbers on the devices. In yet another application, visual display material may comprise a musical symbol and the sensory response may be an audio musical response. In an example in which the characterization comprises audio output material, this may comprise the audio equivalent of any of the examples of visual display material given above. Each device therefore includes at least a visual display device for presenting the current individual characterization of the block as a sensory output, with each device typically also including an audio generator.

The system in EP 1899939 is therefore particularly effective as a learning tool—although other applications are explained—since a user is able to manipulate the blocks in the context of game play to produce a meaningful logical or artistic outcome that is itself reinforced by sound and/or images.

Enablement of image re-mapping and measurement of a known object's relative position, distance from and orientation to a single camera is well documented in the field of 3D imaging and robotics imaging. The research and teaching of such image analysis strategies and related publicly available documentation at professional, amateur and graduate level is rich and the following are merely exemplary of techniques applied in the field of the distance estimation and object resolution:.
1. http://www.cs.rutgers.edu/˜elgammal/classes/cs534/lectures/Calibration.pdf. This paper describes calibration techniques for a single camera to determine an objects position in 3D space
2. http://www.asl.ethz.ch/education/master/mobile_robotics/E03_Exercise3.pdf This paper generally describes omnidirectional range finder implementations in a higher education teaching exercise and also includes examples of image remapping.
3. http://www.ijicic.org/ijicic-10-05015.pdf. This document generally describes measuring the 3D position, distance and orientation of a vehicle number plate) using a single camera.
4. http://www.pronobis.pro/software/unwrap/. This document generally describes a software application for unwrapping images captured using 360 degree optics.

### SUMMARY OF THE INVENTION

The invention is a method and apparatus and system of broadcasting light emitted from at least part of a display screen (such as pixels near or at an edge) of a processor controlled device, such as a smartphone, by selective control (such as modulation of output intensity, shape and/or colour change) of at least one pixel or a group of pixels on display screen, to broadcast or communicate information or data, which is redirected via the input of an optical structure so as to be broadcast from an output of that optical structure, such as a reflecting surface or wave guide, preferably in a different plane that may, for example to be orthogonal to the plane of the display. In this way, the emitter optical structure(s), which are positioned about a device's display screen, permits broadcast of data, and enables communication with a second device enabled having a photodetector and control logic responsive to and capable of resolving the broadcast. Optionally the broadcasting device and the receiving device may be one and the same device.

Orthogonality is particularly relevant to an environment where devices lay on or close to a table or flat surface, although the output and optical coupling is equally applicable to generating a near hemispherical field of data communication that makes use of pixels in an existing display as a means of secondary wireless communication of data.

In a complementary fashion, a receiving device may include an optical structure(s), such as a prism or waveguide or a reflector, which may be positioned about an existing camera lens system to permit that camera lens system to resolve optical control data (optical object) and to determine the relative position of that optical object with respect to itself, for example by angle(s) and distance.

Moreover, an enabled device may selectively and directly address, e.g. by IP address, another enabled device and communicate wirelessly by a broadcast means e.g. by Wifi or Bluetooth® having previously determined the relative position of another enabled device associated by its IP address or other unique identifier, the said addressed communication may be least in part dependent on the relative positioning between the devices and optionally the context of the intended interactive activity between the devices.

The emitted control data can effect operation of the local receiving device and may be indicative of content. The optical structure therefore permits transmission of control data about the smart device in any direction(s) and said control data may be indicative with respect to identifying individual side or edge surfaces or a position on a device or orientation of the device and may be associated with one or more specific pixels of the communication processor controlled device containing the integrated display.

According to a first aspect of the invention there is provided a means of enabling data communication from a first processor controlled device e.g. computer tablet or smartphone (“smart devices”) by attachment of, positioning of or by integration of an optical structure, such as a waveguide or light reflector, to enable an emitted optical signal presented as an optical object to be received by a second smart device or by the same smart device enabled with a photodetector array, such as a smartphone or tablet device with a camera. The emitting optical structure redirects a selected portion of the smartphone's display screen which displays an optical object source image or information-bearing pixels. The optical emitting structure re-directs the image presented on the display pixels so that part of or the entire presented image is made visible to a receiving device's photodetector array in normal operation, although the emitter and/or receptor optical structures may modify the input image during transmission and the nature of the modification will be dependent on the material(s) used and the design of the optical structures as will be understood. The image output by the optical structure and originally presented by pixels on the display may take a number of forms and be changeable including colour, shape, which may be influenced for example by a light patterns presented by an array of pixels and/or determined by the arrangement and geometry of the optical structure(s)] and/or modulated light levels such as realized by light semaphoring.

An optical structure attached to, positioned to or integrated with the receiving smart device's photodetector array allows the emitting smart device's optical output via the optical emitter structure to be acquired and information conveyed/broadcast by the optical object to be sensed and interpreted. The optical object therefore permits at least the relative position of the transmitting smart device to be derived, and optionally permits other data relevant to interactive activity to be communicated, calculated and assessed. Such other data may be, for example, an IP address or identity information associated with one particular side face, including front and back sides or broadcasting device's relative orientation of a broadcasting smart device.

The optical structures may be for example a simple snap-on waveguide frame, easily assembled on or about an existing hardware device. The optical structures are low cost and may be functionally integrated into new smart devices to provide new additional communication paths that depend merely on the presence of a display and/or camera and appropriate control programs, e.g. a downloaded “app”.

Generated optical data coded through selected pixels and communicated through optical structures permits suitably enabled smart devices to be aware of the relative positions and optionally aware of the relative orientation of nearby enabled devices. Such position-awareness produces an interactive activity environment in which two or more collocated enabled smart devices uni-directionally or bi-directionally communicate information through the optical structures. Communicated information, such as via light patterns or light modulation, allows receptive control logic to resolve the relative position, orientation and relative distance of compatible collocated smart devices.

Communication of data may be at a relative low baud rate via the optical structures and may be used to establish an initial link to another device and in the process having also identified the other device's relative position, thereafter a relatively high baud rate link between specific IP address-identified smart devices is established via a different communications protocol e.g. Bluetooth® or Wifi subsequently established between those specific devices. Communication via the optical structures typically supports communication over relatively short distances ranging typically from a few millimetres to up to about a metre; the distance is subject to optical resolution and attenuating effects, as will be understood.

With downloading of a software application, a smart device's functionality can be augmented and its use changed to support a diversity of interactive activities involving other devices and based on at least their close proximity. Moreover, with relative position awareness of other smart devices and optical communication capabilities supported by the optical structures herein described, a smart device can send data and acquire the relative position and identification information of other nearby devices. Once optical communication is established, a network of interacting smart devices can selectively transmit and/or receive larger data payloads by other wireless air interfaces, such as for example ^{Bluetooth}® or WiFi and which data is preferably based on the determined relative positions of each smart device.

The optical emitter structures and optical receptor structures therefore provide a low cost means of providing smart devices with a sense of relative position of nearby compatible devices, and a communications environment which provides for rich interactivity. Position aware interacting smart devices find applications which include (but are not limited to) games, education, industrial, retail and medical situations and control of other devices by optical coupling in general device interfacing. Applications are, in fact, driven by the content presented on a smart device and the contextual interaction between content on different devices. Communication of content or data communication based on determined relative position can therefore be a simple as a download or instruction, or as complex as information sharing that brings about a change in operation in the smart devices engaged in the interaction.

Advantageously, a preferred embodiment of the present invention communicates data by selectively modulating pixels on the device's display screen and coupling the resultant modulated pixel output to at least one optical structure that functions to direct the optical object data to a second smart device's photodetector, or optionally to the same smart device's photodetector. Typically, the optical structure(s) are realized by prisms, mirrors or moulded light-guide optics, and these optical structures bring about a selective broadcast of data in a plane generally orthogonal to the display, although the plane or FOV is determined by the optical structure design and may be wider. Broadcast optical data is then susceptible to detection by an imaging device, such as an integrated camera within a tablet computer or phone, where the captured images can be analysed to retrieve data. In this overall transmitter-receiver arrangement, communicated optical data may be structured to permit an appropriately programmed controller in a receiving device to resolve a relative position, distance and/or orientation of the emitting/broadcasting device relative to itself.

Additionally, embodiments of the invention are so as to permit a first device displaying visual content, such as text, images and/or symbols and other forms of data content, on its display screen to bring about an interaction with a second proximately located device that is itself presenting visual content on its own independent display screen, to generate a meaningful sensory output indicative of a time-varying interaction arising between the displayed content presented respectively by these at least these two interacting electronic smart devices. The two-device arrangement, based on an evaluated position-awareness and data communication that permits for both control data and/or content related data to be communicated between independent processors, may be extended to multiple devices to support a larger contextual interaction upon resolving relative positions and/or presented content and thereby the relative position and orientation of that content on the respective displays of the multiple interacting devices. In general, the combined interaction of the smart devices reflect the interaction intended in the context of the activity and the relative position of the smart devices to each other, which relative position may include direction and distance as resolved through determination of a set of relative coordinates, such as in 3D (three-dimensional) Cartesian or vector space.

The manipulation of a first device displaying visual content relative to a second device, itself displaying visual content, may cause the user-perceived relative repositioning of the visual content of the first and second devices to change and generate a new meaningful sensory output.

In yet another embodiment, an enabled processor controlled device can communicate control data generated on at least one pixel of a display screen of a processor controlled device via an optical structure to another system (e.g. an electromechanical or electronic system), enabled with at least one photodetector and may provide superior performance of the combination of the processor controlled device and the simple system.

The instant invention, in contrast with EP1899939, additionally describes at least: 1) an optical structure that supports a new and useful communications path; 2) a fine degree of relative position determination of nearby devices; 3) an ability to resolve finely the orientation of nearby device and content and/or objects presented on that nearby device; 4) a means of selectively communicating with another device based on the determination of the other devices relative position and addressable identity; 5) a means of communicating with and preferably controlling another structure (e.g. an electromechanical or electronic system); 6) a means of communicating control data using light emitted from the screen of a smart device to be detected by the photodetector(s) or camera device(s) of the same smart device.

### BRIEF DESCRIPTION OF THE DRAWINGS

Exemplary embodiments of the present invention will now be described with reference to the accompanying drawings in which:

FIG. 1A illustrates an example of optical structures according to preferred embodiments of the present invention of an optical receiver structure.

FIG. 1B illustrates an alternative example of optical receiver structure.

FIG. 1C illustrates a further alternative example of optical receiver structure.

FIG. 1D illustrates a further alternative example of optical receiver structure.

FIG. 1E illustrates a further alternative example of optical receiver structure.

FIG. 1F illustrates alternative examples of optical structures and optical waveguide structures for broadcasting data and an exemplar arrangement about a display screen.

FIG. 2A illustrates an exemplar optical object being emitted by an optical structure

FIG. 2B illustrates an exploded view of optical structures of FIG. 1A to 1F shown mounted on a smart device, such as a tablet computer or smartphone.

FIG. 2C illustrates an assembled view of FIG. 2B

FIG. 3 shows, in accordance with a preferred embodiment, an example process of relative position calibration between two interacting devices;

FIG. 4A shows a side view of the interactive devices of FIG. 3 communicating within their Field Of View (FOV);

FIG. 4B shows a mainly top view of FIG. 4A.

FIG. 5 illustrates, in the exemplary context of a game, relative position aware interactivity between two smart devices and the respective content on each device, having relative displacements and relative orientations;

FIG. 6 illustrates a preferred but exemplary process by which an enabled smart device of may optically identify the relative position of a second nearby smart device and associate that second device with its addressable identity (ID);

FIG. 7 shows an exemplary process by which the enabled smart devices may interact in an activity or game;

FIG. 8A illustrates a top view example of resolvable visual image effects with respect to orientation, relative position and distance of interacting nearby smart devices.

FIG. 8B illustrates a top view example of resolvable visual image effects with respect to orientation, relative position and distance of interacting nearby smart devices in an alternative relative position, moved upwards in the view.

FIG. 8C illustrates a top view example of resolvable visual image effects with respect to orientation, relative position and distance of interacting nearby smart devices in an alternative relative position, both devices on the same surface.

FIG. 8D illustrates a side view example of resolvable visual image effects with respect to orientation, relative position and distance of interacting nearby smart devices in an alternative relative position, one device manipulated to not be on the same surface as the other.

FIG. 8E illustrates a top view example of resolvable visual image effects with respect to orientation, relative position and distance of interacting nearby smart devices in an alternative relative position.

FIG. 8F illustrates a top view example of resolvable visual image effects with respect to orientation, relative position and distance of interacting nearby smart devices in an alternative relative position, one device moved so as to be orientated (angled) differently from the other device.

FIG. 9A shows a device with two optical structures according to FIG. 1A to 1F.

FIG. 9B shows a side view of representations of the preferred FOV of the preferred optical structure of FIG. 1A to 1F and the smart device's imaging module.

FIG. 9C shows a further alternative side view of representations of the preferred FOV of the preferred optical structure of FIG. 1A to 1F and the smart device's imaging module.

FIG. 10A shows, in accordance with preferred embodiments of the present invention, an offset view of exemplary positioning arrangements of preferred optical structures of FIG. 1A to 1F as shown in situ on a smart device;

FIG. 10B shows a top view of the arrangement of FIG. 10A

FIG. 11 illustrates an application of the present invention in the context of a smart device controlling another processor controlled system which may also be a simple system or a number of simple systems.

FIG. 12A shows an example of an optical emitter structure

FIG. 12B shows an example of an optical emitter structure with a Light Emitting source other than the display panel source

FIG. 12C shows a possible arrangement of a plurality of optical emitter/reciever structures about a smart device.

FIG. 12D shows a side view of the arrangement of FIG. 12C.

FIG. 12E shows an example of an optical structures arrangement and an example of apertures through which a user interrupt the optical emissions.

FIG. 12F shows a side view of an example of a user deflectable optical emitter structure.

FIG. 12G shows a offset view of an example of a user deflectable optical emitter structure of FIG. 12F.

FIG. 12H shows an example of a possible arrangement of a plurality of optical emitter structure of FIG. 12F.

FIG. 13A illustrates a largely front view of an application of the present invention in the context of optical control of multiple simple structures placed on or about a smart device.

FIG. 13B illustrates a largely side view of FIG. 13A.

FIG. 14A illustrates a largely front view of an assembly of the present invention in the context of a smart device (not shown) controlling one or more simple systems (assemblies).

FIG. 14B is a front view of the present invention in the context of a smart device controlling one or more simple systems (assemblies) placed on or about a smart device.

FIG. 14C is an offset view of FIG. 14B.

### DETAILED DESCRIPTION OF A PREFERRED EMBODIMENT

The term “smart device” will unless the specific use of the term requires a more limited or specific definition evident from the surrounding context, be understood to mean any computing device, including a smart phone or tablet. The smart device is further configured with optical structures including an optical waveguide and/or reflector and programmed with appropriate software/firmware control logic to permit, in accordance with the various embodiments of the present invention, the emission and/or reception of optically encoded control and information data/bits in a plane or planes determined by the design of the optical structures about either a display screen or a lens of a camera system or imaging module.

The term “content” will unless the specific use of the term requires a more limited or specific definition evident from the surrounding context, be understood to mean any material presented on the display screen of a device and which may be an image comprising of a number of discernible individual objects represented in the image. The objects may each have individual and changeable orientation and individual and changeable positions relative to the boundary sides of the display screen. The objects themselves may be individually and contextually relevant with respect to both the image in which it is presented and to objects and content displayed on the screens of other devices involved in the interactive activity. Objects presented on the display screens of other devices involved in the interactive activity have relative orientation and relative positions to at least some of the objects displayed on other devices as required by the activity], as will be understood .

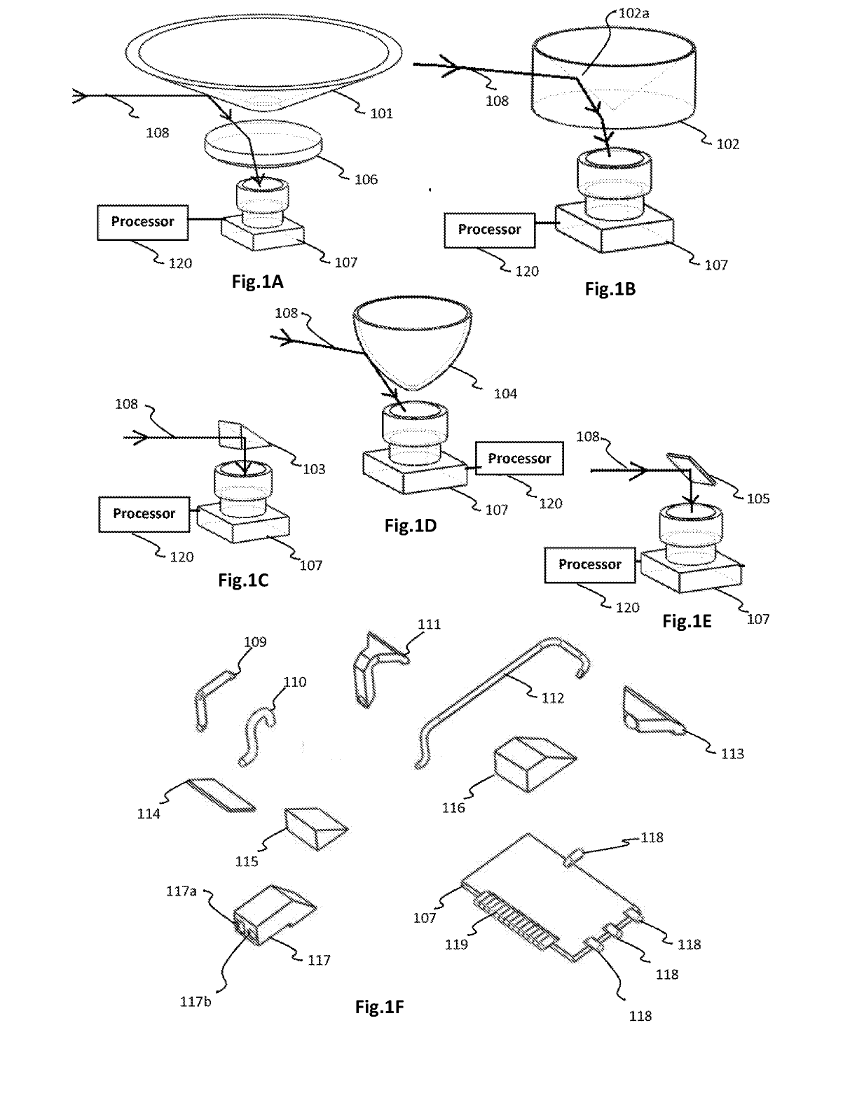

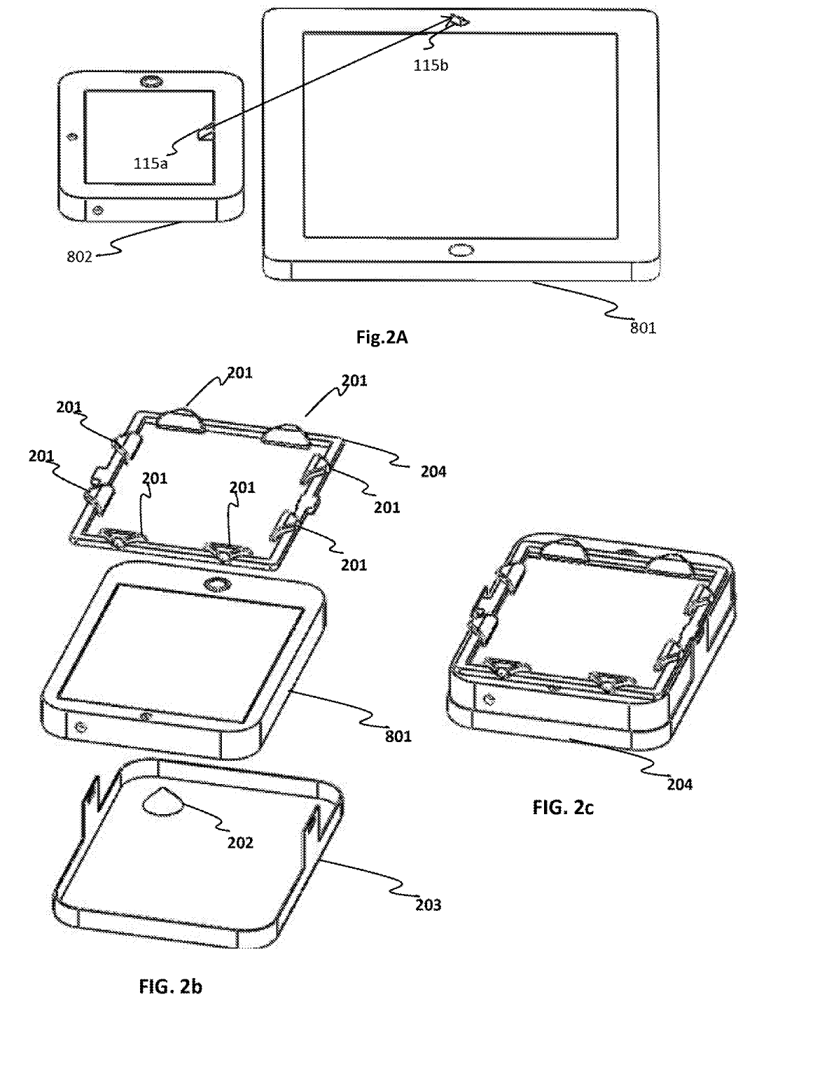

The term “optical object” will unless the specific use of the term requires a more limited or specific definition evident from the surrounding context, be understood to mean any optically emitted observable pattern presented at the output face of an optical structure(s) which optical structure(s) optical input is at least optically coupled to, arranged to be close to or positioned upon a detectable light emitting display panel e.g. OLED or TFT. The optical object may be generated by the combination or arrangement of more than one optical structure's optical outputs. It will be understood that the optical object and its observable FOV is dependent on the design of the optical structure and/or the combination of multiple optical structures. By observable it will be understood to mean observable by a camera system or imaging module including a photodetector(s). Distortion or modification of the input image with respect to the output image caused by the optical characteristics of the materials and design of the optical structure will be understood. It will be appreciated that the optical object source image generated by the selected pixels of the display screen may be redirected with little distortion by at least first or second surface reflection. A single optical object e.g. of FIG. 2d may be employed with any multidirectional emitter optical structure such as that of FIG. 1a to simultaneously broadcast different communications to an observer(s) or observer device depending on the relative position of the said observer(s) as will be readily understood.

The terms “optically coupled” or “coupled” will unless the specific use of the term requires a more limited or specific definition evident from the surrounding context, be understood to mean any optical evanescent-wave connection, redirection by reflection or any methods known in the art which enable light waves to travel from one waveguide to another or light waves to be reflected by a suitable surface or by a focusing element(s) such as a lens(es) or any combination thereof.

The term “photodetector” will be understood to include but not limited to any of photodiodes, phototransistors, photodarlingtons, photologic detectors, CMOS or CCD imaging sensor, photoconductive cells, photosensitive sensors, photo responsive materials and any sensor and/or device responsive to light waves or photonic radiation of any wavelength, as will be understood.

To provide an operational context for the present invention optical structures, examples shown in FIG. 1A to 1F, provide a means of broadcasting an optical object originally presented by a selected portion of pixel(s) of a display. An optical object may be realised by a pixel array pattern emitted from a display screen, such as for example a light emitting Liquid Crystal Display (LCD), Thin Film Transistor (TFT) display or Organic Light Emitting Display (OLED) display of a smart device (processor controlled device), to which the optical structure is positioned close to or directly onto. The optical object is changeable by modulating the pixel output associated with or optically coupled to the input of the optical structure. As display screen pixel arrays and the resultant optical objects are changeable under processor control, they may also be used to communicate information or data.

The optical object may be simple, for example a single fibre optic coupled to redirect light output from one or a small number of pixels of a smart device's display screen or may be complex for example a portion of the display screen configured to display a pattern of an array of pixels and reflected by a mirror to enable the optical broadcast of the pattern. The pattern of the optical object may be deliberately generated to be identifiable by another smart device, such as through a particular shape assembled from pixels and/or a colour. Additionally and/or optionally, the pixels can vary the level of their output intensity between, for example, one of 2ⁿ levels of intensity (as may be determined by the capabilities of the display screen) and may have different colour elements e.g. red-green-blue (RGB).

FIG. 1A to 1F represents a number of exemplary optical structures which may be used by smart devices to enable the transmission (FIG. 1F) or reception (FIG. 1A to 1E) of optical objects and optionally data, such as specific information or specific content. It will be appreciated that optical structures may be fabricated from optically transparent materials and reflecting materials, a combination of the aforementioned or by methods and materials commonly known in the art. Optical structures may also be integrated with any device including but not limited to light sensitive devices e.g. camera system, a photodetector, a charge coupled device (CCD), a Complementary metal-oxide-semiconductor (CMOS), Optical structures may also be integrated with any device including but not limited to any light source e.g. a light emitting diode (LED), a display screen or panel such as an OLED or TFT panel. An optical structure may also a simple open sided and/or open ended light shutter e.g. a tubular conduit, an aperture e.g. pinhole or any other design as will be understood by a person skilled in the art, which may serve to partially or fully isolate at least one selected pixel or a selected array of pixels of a display so as to allow the output of that at least one selected pixel or selected array of pixels of a display to be detectable by at least one photodetector, preferably the optical structure providing sufficient isolation from other unwanted light such as ambient light to enable the transfer of an optical signal or data between the input and output of the optical structure. It will be appreciated that in preferred embodiments where the light source may be relatively close to the light detector, a lens system which may be attached to a photodetector or an array of photodetectors may be sufficient to provide the desired isolation and is construed to be an optical structure in the instant invention.

Although some of the optical structures of FIG. 1A to 1F more naturally lend themselves to one of reception or transmission of image data based on their physical construction, optical characteristics and their ability to interface with either a typically planar display screen or a camera lens system, it is appreciated that all of the examples may be used or adapted for both transmission and reception of light. It will also be appreciated that the optical structures may be rigid or may be flexible allowing applied pressure, for example pressure applied purposefully by a user's finger, to modify shape of the optical structure and reposition the portion of the optical structure where the light or optical object exits or enters the optical structure.

FIG. 1A shows a conical reflector 101 which may be solid or hollow and may have an internal aperture to allow the camera (in a smart device or otherwise connected to a device) to function normally, albeit with a reduced field of view. The internal apertures may also permit the sensing of optical objects in a FOV about the usual coaxial axis of the camera. The conical reflector 101 simultaneously allows a Field Of View (FOV) generally about an axis perpendicular to the camera axis. In a preferred arrangement, an optional supplementary lens 106 is located in the light path. An imaging module 107, which may be integrated into the smart device or connected externally, communicates a captured image—falling incident onto a suitable detector, such as a CCD (not shown)—to a processor 120 (or a number of processors) for processing on the image to recover data. Processing therefore permits recovery of information initially coded into the optical object as presented on the display of a suitably enabled device and selectively broadcast from that enabled device from one or more optical structures associated with specific faces or relative orientation of the broadcasting device (which may also be a smart device).

More specifically, incident light 108 from anywhere within the FOV of the combined optical element relay (all of the optical elements in the ray path of the incident light including at least the optical structure) is directed by the elements of the optical element relay to the imaging module 107 and the image is further processed by the processor 120. Typically, given the general conical shape of the reflector, it will be understood that the FOV may be a generally 360° view around the perimeter of the smart device to whose camera system the conical reflector is attached or positioned to. The imaging module 107 and processor 120 perform similar functions in FIG. 1B to 1E.

FIG. 1B represents an alternative optical structure arrangement where the reflector is an internally reflecting cone structure 102. FIG. 1C represents an alternative optical structure arrangement where the reflector is an internally reflecting prism structure 103. FIG. 1D represents an alternative optical structure arrangement where the reflector is a curved 360° first surface reflecting structure 104. FIG. 1E represents an alternative optical structure arrangement where the reflector is planar reflecting mirror structure 105.

FIG. 1F structures identified as reference numbers 109-113 are additional examples of optical structures which redirect light by total internal reflection (TIR). Generally, optical structure 109-113 are light guides in the form of pipes or prism that are arranged to direct an image, projected in a first plane, to be bent so as to project coherently the same image in another orthogonal plane or any plane dependant on the direction of the guide output. In other words, an image, in the form of light from selective illumination of one or more pixels on a display, can be projected tangentially and generally laterally from the device, with this image data supporting data coding. A first or second surface of a mirror 114, a prism 115 and/or a modified prism 116 may also redirect emitted light from a light source, such as the pixels of a display screen of a smart device.

The shape and orientation of optical structures relative to the camera or imaging module defines the FOV of the emission system or receptor system and therefore it may not be limited to a general lateral plane if so required by an application as will be understood.

A photodetector or photodetector arrays connected to a smart device or a device with a microprocessor may also serve to perform the function of the imaging module or camera in detecting the relative position and optionally identity (ID) of an emitted light source.

FIG. 1F represents an example arrangement of multiple light directing optical structures 118 which may be arranged in a pattern or as an array 119 on a display screen 107 to permit emitting structures to be identified by observation by an imaging module or camera of a remote smart device with which interaction is potentially desired. The array 119 therefore maps pixels or groups of pixels preferably as a coherently light pattern to specific optical outputs at each remote end of each light guide. The array 119 may be used for example to allow the relative orientation of a device, to be identified by different numbers of outputs from light emitting structures 118 or different physical positions of the outputs from specific light guides or a combination of output position, number of output, shape of the image, shape of the light guide output, intensity of the light and/or colour from an output.

It will be appreciated that while the light path 108 is shown with arrows indicating the light is incident to the optic, optical structure examples 101-105 may all be used to reflect light emitted from a display screen about which they are positioned, i.e. they may also be used as emitter optical structures.

It will also be understood by a person skilled in the art that the optical structures described in FIG. 1A to 1F are for illustrative purposes only and the design, size and shape may be modified in a number of ways to achieve the desired purpose as will any supporting arrangement to maintain the position of any optical structure to the display screen or the photodetector(s) as required.

It will be appreciated that the shape of the reflecting surface could also be a simple curved surface e.g. spherical, a complex freeform shape or a linear shape and that the redirection of the light by the emitter optical structures and the receptor optical structures may be achieved by at least one of TIR, partial internal reflection or first surface reflection or by any alternative principles readily known in the art. The emitter optical structures and the receptor optical structures of FIG. 1A to IF are examples only and it will be appreciated that light may be redirected in both directions by any of the example optical structures as required by the application. Indeed, the emitter optical structures can function as receptor optical structures and vice versa. Optical structures may be a single element such as a mirror or prism or may be a combination of multiple optical elements arranged to redirect light as required by the application. An optical structure may itself be a combination of one or many optical elements and/or additional optical structures in any arrangement as required by any application.

### Preferred Embodiment of Relative Position Aware Apparatus

FIG. 2A to 2C shows example implementations of the optical structures arranged to enable optical communications between two smart devices 801, 802.

FIG. 2A represents the embodiment of a simple optical communication arrangement whereby optical structures 115, in this example a prism 115a, is placed on the display screen of smart device 802 so as to redirect the display pixel output directly under the prism in another direction. A second prism 115b is placed on the camera aperture of the second interactive device 801 so as to allow light to be redirected from a general horizontal plane into the usual axis of FOV of the camera of smart device 802. It can be appreciated that light emitted from display pixel output of device 802 directly under the prism 115a on device 802 is made visible within the FOV of device 801 enabled with the prism 115b.

The two devices 801, 802—which are typically both smart devices, although this need not be the case—may be moved relative to each other, but nevertheless may remain detectable within the FOV of the camera of detecting device 801 and thus in interacting communication.

In another embodiment, devices 801, 802 may both have one or more emitter optical structures (such as preferably shown in FIG. 1F) and one or more receptor optical structures, such as preferably realized by the cone structures shown in FIG. 1A to 1E.

FIG. 2B shows a representation of optical structures integrated into an upper part 204 and a lower part 203 of a fit-around case, such as protective case for an iPhone®. The two parts 203, 204 are assembled about a smart device 801 to enable bidirectional optical communication.

Upper part 204 has a number of optical structures 201 arranged, when assembled about the smart device 801, to optically couple light emitted by selected regions of the screen of the device 801 into a different plane. As will now be understood, the optical structures act as light guides and redirect the light to each side according to the direction of the particular optical structure 201.

The lower part 203 incorporates a receptor optical structure 202 which is located so as to redirect light to the FOV of the imaging module or camera of device 801. The lower part 203 will typically have sides which are transparent to light frequencies desirable for communication purposes. FIG. 2C shows the assemblage of the structures of FIG. 2B.

It will be appreciated that the examples in FIG. 2A to 2C are for illustrative purposes only and the number of devices which can interact is not limited to two. The types of devices 802, 801 are purely exemplary and multiple different smart devices or multiple similar smart devices may interact using optical structures. Similarly the field of view (FOV) of both emitter optical structures and receptor optical structures are defined by their physical placement and optical design. In the instance of receptor optical structures, the combined optical characteristics of the total optical path (normally referred to as an optical elements relay) defines the FOV, for example the receptor optical elements relay path may consist of an optical receptor structure, a supplementary lens, the smart device camera focussing optics, the camera photodetector array colour filter and the micro-lens array above the photodetector element.

### Example Calibration of Device Relative Position

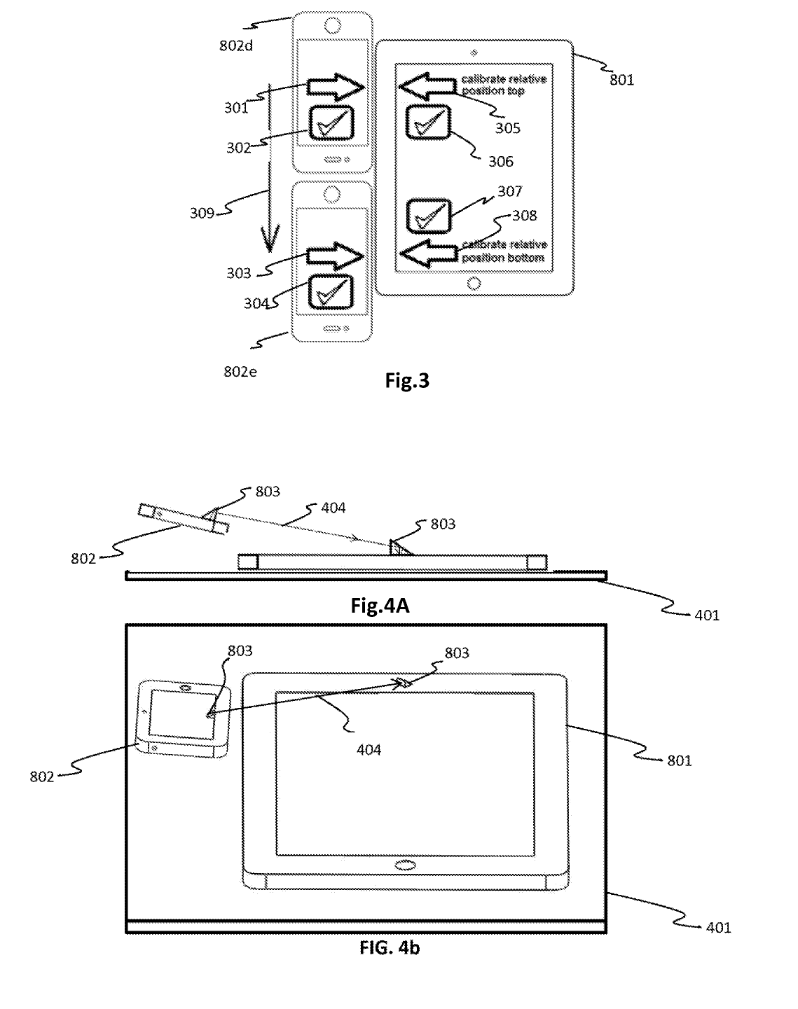

FIG. 3 is a diagram showing an example process of a preferred embodiment by which the relative position of a second device 802d, 802e is determined by a first device 801. For the purposes of clarity, the optical structures which are required by both devices have been omitted in the drawing.

Device 802e is the same device as device 802d; the two representations of smart device 802d and 802e simply represent the movement with time along the right hand edge of device 802 during the process of calibration. If the size and pattern of an optical target (i.e. the pixel pattern output from the display and routed via the optical structure(s)) is unknown, a calibration process may be required to initialise communications between two devices realised by, say, a Galaxy° tablet Samsung° and an iPhone® from Apple®, Inc. The devices could, however, be both the same type and either one of the devices may effectively take the lead in calibration by acting as a master rather than a slave.

Tablet device 802 may initiate the process by displaying, upon user instruction or as part of the initialisation of the program controlled activity , an arrow 305 on its display screen and displaying a calibrate command in text alongside.

During an instantiated calibration mode for device 802d-e, the device will generate an arrow 301 that must be aligned with the arrow 305 presented on the tablet device 801 With human movement of one or both of the devices, the human operator aligns the two arrows and then presses a tick button 302 (on a touch sensitive display of device 802d/e) to indicate acknowledgment of device alignment.

Tablet device 802 will then delete both its displayed arrow 305 and tick indicator 306 and display new indicators and commands 307, 308.

Device 802d can now be moved to its next position, 802e, and the alignment acknowledgement process repeated.

If required, to fully calibrate each edge of each device, many alignment positions—generally at least one per edge—are typically taken around one or both peripheries of the proposed interacting devices, thereby permitting direction and relative vector displacement to be resolved by both of the devices computing platforms, e.g. their respective microcontrollers. However, if device 801 only requires an intelligence of the optical object size and configuration presented by device 802d, the calibration procedure may only need to be done once in a known position.

FIG. 4A to 4B shows an example of two devices that do not share a common flat surface (such as table top 401). In other words, the devices are potentially spatially inclined to each other and do not share a common reference plane.

Each device 801, 802 has an optical structure 803; this may be an optical structure similar to any described in FIG. 1A to IF or of any alternative design serving a similar purpose as will be understood by a person skilled in the art. The respective optical structures 803 are appropriately positioned over pixels and camera optics so as to enable communication, as described above.

Although relatively inclined through being handheld in free space, it will be understood that line-of-sight 404 allows device 801 to acquire an appreciation of the relative position of device 802 (and vice versa). The field of view (FOV) of both emitter optical structures and receptor optical structures are defined by their physical placement and optical design. In the instance of receptor optical structures, the combined optical characteristics of the total optical path defines the FOV, for example, the receptor optical path may comprise of an optical receptor structure, a supplementary lens, the smart device camera focussing optics, the camera photodetector array colour filter and the micro-lens array above the photodetector element. The FOV available to a smart device enabled with an optical structure further depends on the design and placement of the optical structure. The FOV available to a smart device may extend to be almost hemispherical, incorporating a 360° degree FOV about the coaxial usual axis of the smart device camera and extending to, or near to, a 90° degree angle from the plane of the device body. Preferably, the FOV may be generally hemispherical in field.

### Example Interactive Activity Between Multiple Devices

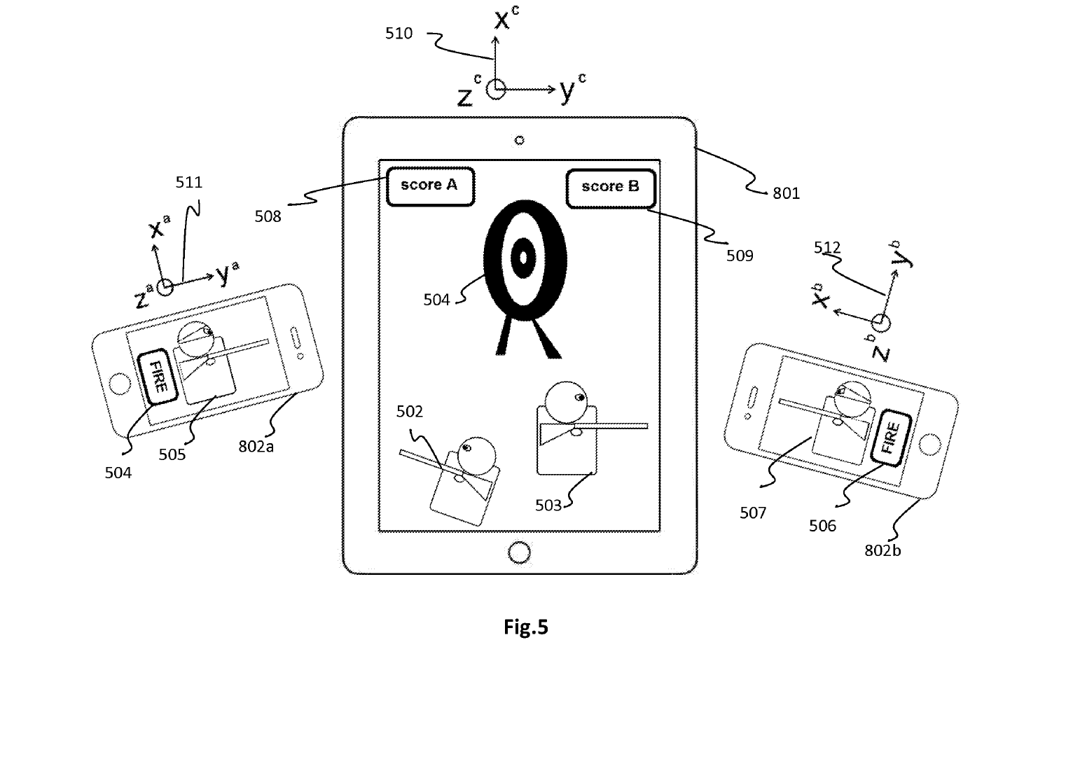

FIG. 5 illustrates an example interaction between multiple devices 802a, 802b, 801. In accordance with the real-world effect brought about by the present invention, the interaction is dependent on at least one of: i) the relative positions of the devices; ii) their relative orientations; and iii) the relative positions, orientations and/or nature of objects (collectively may be referred to as content) displayed on their respective display screens in the context of the activity or game, i.e. the contextual relevance of one object to another and the impact that one displayed object (or the function that it represents) has on another displayed object.

In the example of FIG. 5, the displayed objects are (a) buttons 504, 506, (b) character depictions 502, 503, 505, 507, (c) a target 504 and (d) score panels 508, 509. By way of one example, the user manipulates—and thus orientates—device 802a so as to point the representation of a gun held by character 505 at the target displayed on the touch screen of device 504. The user of device 802a may press the “fire” button 504 to cause a shot to be fired at the target 504, with control logic in the game allowing the trajectory of the bullet to be displayed at the point of leaving the gun barrel and exiting the touch display of device 802a. Contextual interaction, through signalling in accordance with the invention described above, allows the bullet to appear at an appropriate entry point on the display of device 801, and further displayed moving towards the target 504.

In a similar fashion, a second user may manipulate device 802b so as to orientate character depiction 507 to attempt to shoot the target 504 presented on remote device 801.

The respective successes at hitting the target 504 may be shown on score panels 508, 509 presented on at least display 801.

The character depictions 502, 503 on tablet device 801 may, at the same time, be attempting to defend the target 504 by shooting the characters depictions 505, 507 under the programmed control of the processor of device 801.

Therefore it can be appreciated that manipulating the devices 802a, 802b relative to the device 801 so as to orientate displayed objects on each device relative to each other brings about a purposeful and meaningful interaction in the context of the activity or game. In the real world, the interaction brings about a perceivable change in output of one or more of the interacting devices. Moreover, through optical signalling in accordance with the arrangements of FIG. 2A to 2C, it will be appreciated that each device is aware of the relative position of any other devices with which it is interacting. For example, smartphone device 802a is aware of the relative position of tablet device 801. Each device is also aware of relative device orientations. Each device is also aware of the relative positions and orientations of objects displayed on the device display screen and the relative positions and orientations of objects displayed on the display screen of another device involved in the interactive activity. For example, device 802a is aware of the object character 505 displayed on its display screen and the direction in which the gun of object 505 is pointing. Device 802a is also aware of the relative position of tablet device 801 and the relative position, distance and orientation of the target 504 as presented on the display of tablet device 801 relative to its presentation and orientation of character depiction 507 and the gun which is being aimed by character depiction 507.

All data communication, but at least relative position information, can be accomplished via selective modulation of display pixels on individual displays. When desired and higher bandwidth data is required because of contextual orientation or specific command, pixel modulation techniques may be augmented by other localised air-interface protocols having generally point-to-point or near vicinity addressing of identified devices, as indicated above.

Smart devices may also determine their own positions in a wider 3D space from their own Global Positioning Systems (GPS) and this GPS data may be used within a geographically wider interactive set of smart devices.

### Example Identifying a Device by Relative Position and Wireless ID

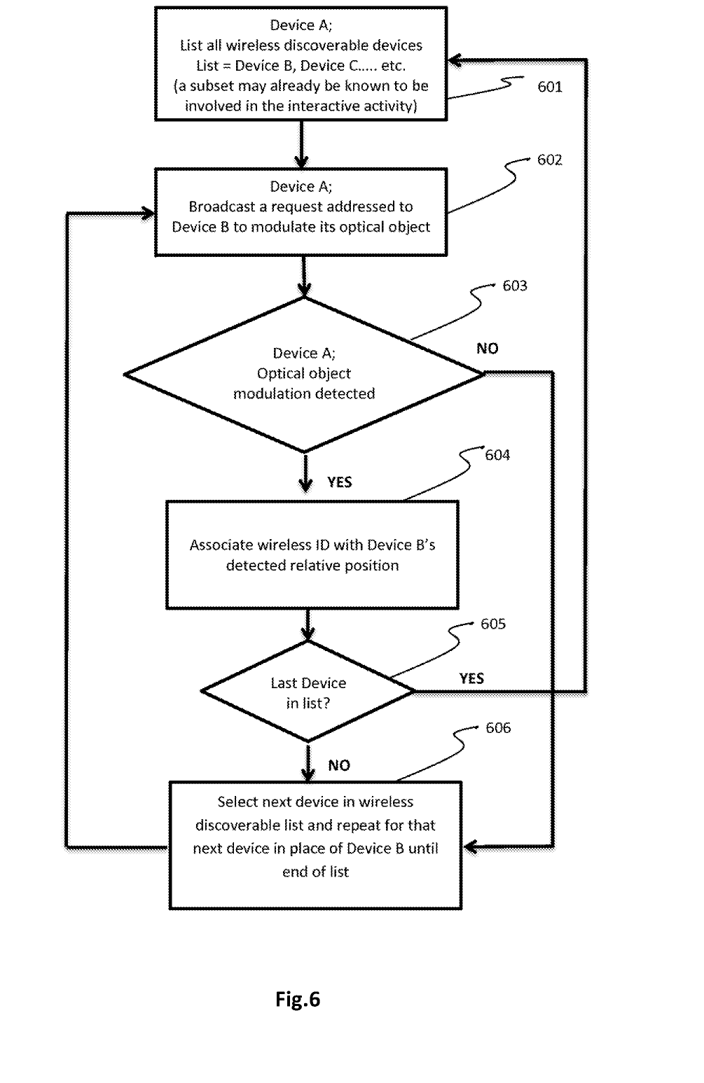

FIG. 6 is an example process by which a smart device Device A may discover other nearby wireless devices, list the devices' wireless unique IDs and determine the relative position of the listed devices.

It will be understood that wireless devices generally each have a unique wireless identity (ID) e.g. IP address (or otherwise may have an ID assigned by a user or the activity software program designer/programmer). It will further be readily understood that, by using a device's wireless ID, a specific device may be selectively addressed and communicated to in a wireless broadcast.

At step 601, Device A discovers all discoverable wireless devices in its range and lists them. At step 602, Device A then starts with the first device, in this example Device B, in the list and broadcasts a command addressed uniquely to Device B to cause Device B to modulate its optical object, e.g. selective pixels on its display assigned to control purposes. Consequently, a first air interface is used to establish contact between devices, where after the optical communication path of the preferred embodiment is then instantiated for additional communication of control data and/or information including that required to determine relative position of a device in the list.

At step 603, Device A acquires output images from its imaging module and processes them to determine if a detectable change in optical objects from Device B has occurred. If a change in optical objects has occurred, Device A can associate the relative position of the changeable optical object with Device B.

At step 605, if Device B was the last device in the in-range list, Device A can optionally wait for a short period and repeat step 601.

At step 606, if Device B was not the last device in the list, Device A can select the next device, e.g. Device C, and repeat the process starting at step 601.

By using commonly known visual object tracking techniques, once the initial relative position of a device is determined and associated with its wireless ID, that device can be optically tracked by frequently analysing the optical images (as output via the emitter optical structures) acquired by the imaging module of the tracking device. This can reduce the frequency and necessity for steps 601 to 606 to be repeated.

### Example of Interactive Activity Process

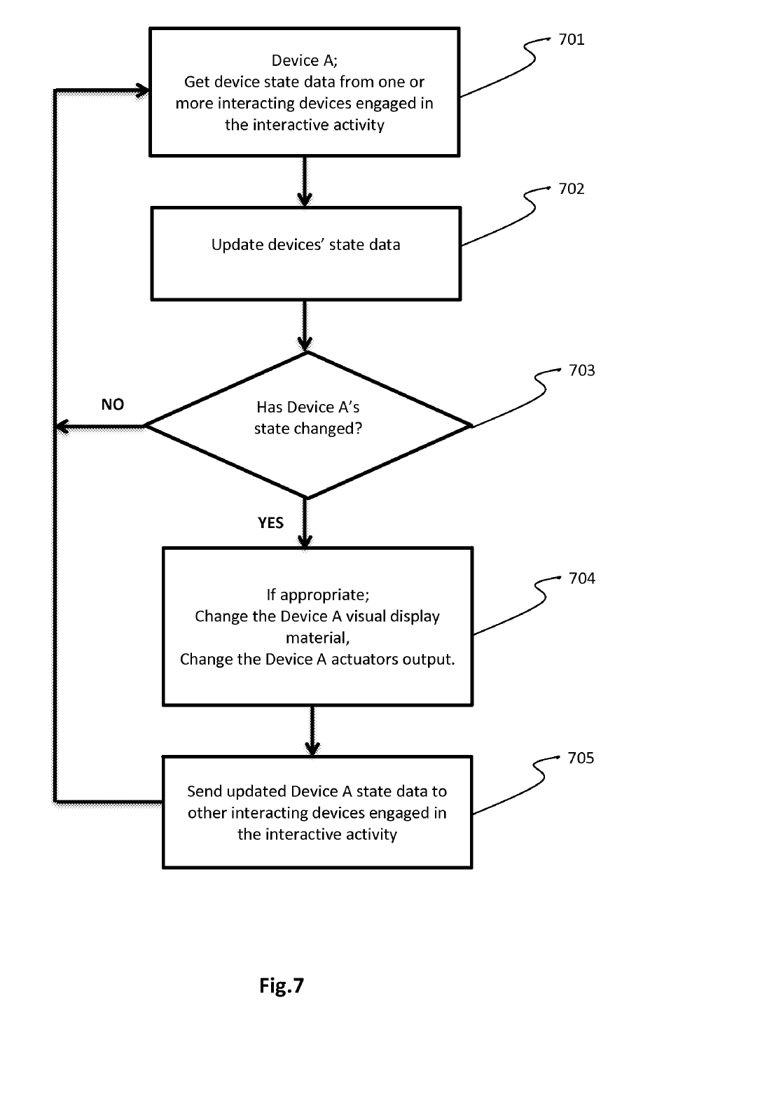

FIG. 7 describes an exemplary process by which a device changes its display material and varies functional operation, such as actuator outputs, in response to changes of relative positions or states of other nearby interacting smart devices.

The inventors have appreciated that the “state” of a device may be described by either its own independent functional state or otherwise and/or its effective combinatorial functional state reflecting contextually relevant interacting content presented by another interacting device. Independent and combinatorial functional states reflect and are influenced by at least one of i) absolute orientation determined by the device's own sensors; ii) relative orientation to another device determined by optical object computation, iii) visual display material and the objects displayed/presented its display screen, where relevant the display material and objects displayed/presented on the proximately located visual displays; iv) device outputs, including audio, haptic and/or vibratory output, and/or; v) device sensor output(s). A change in ‘state’ of an interacting device may therefore be brought about either independently or in any combination by i) user manipulation of the device; ii) user input by any smart device input means e.g. touchscreen input, voice, physical gestures as recognised by a camera system or a tap to be recognised by a device's accelerometer; iii) a program executing on the device; iv) by another device(s) involved in a collective activity, such as a game; v) remote communication/control (over a network or internet), including user or automated programmatic control. Indeed, a change of state of a device need not solely be communicated by optical communication but changes of state can be communicated by supplementary means such as Bluetooth® or WiFi or cellular.

In the process of any activity involving an interacting device, the underlying process follows the exemplary flow path of FIG. 7. At step 701, a device (“Device A”) arranged to receive information describing the state of other interacting nearby devices via the optical output system described herein and shown, for example, in FIG. 2A to 2C, or communicated by wireless means. At step 702, Device A receives optical data or otherwise derives an appreciation of the active state of all other interacting devices. At step 703, the processor of Device A determines if the state(s) of interacting devices bring about, i.e. requires, a programmatic change in its own functional or operational state according to the program executing on Device A's processor. The control logic executing on Device A further determines if a change of state of itself (Device A) has been brought about by its user, by another device or through received information. If no change has been brought about in the state of Device A, then the process returns to step 701. Conversely, if a change in state of Device A has occurred, then the process advances to step 704 where, if determined appropriate by the program executing on Device A, a change occurs. The change that is brought about can be: i) in visual display material presented on Device A; ii) variation of output states for outputs from or peripherals associated with Device A or iii) both in display and Device A output(s). At step 705, Device A communicates its current/revised state to the other interacting devices and then returns to step 701. It will be appreciated that each device engaged in the interactive activity will carry out the process of FIG. 7 to determine the nature of the interactive activity and effect on its own state.

Examples of Optical Object Changes Due to Relative Position and Orientation from Another Device.

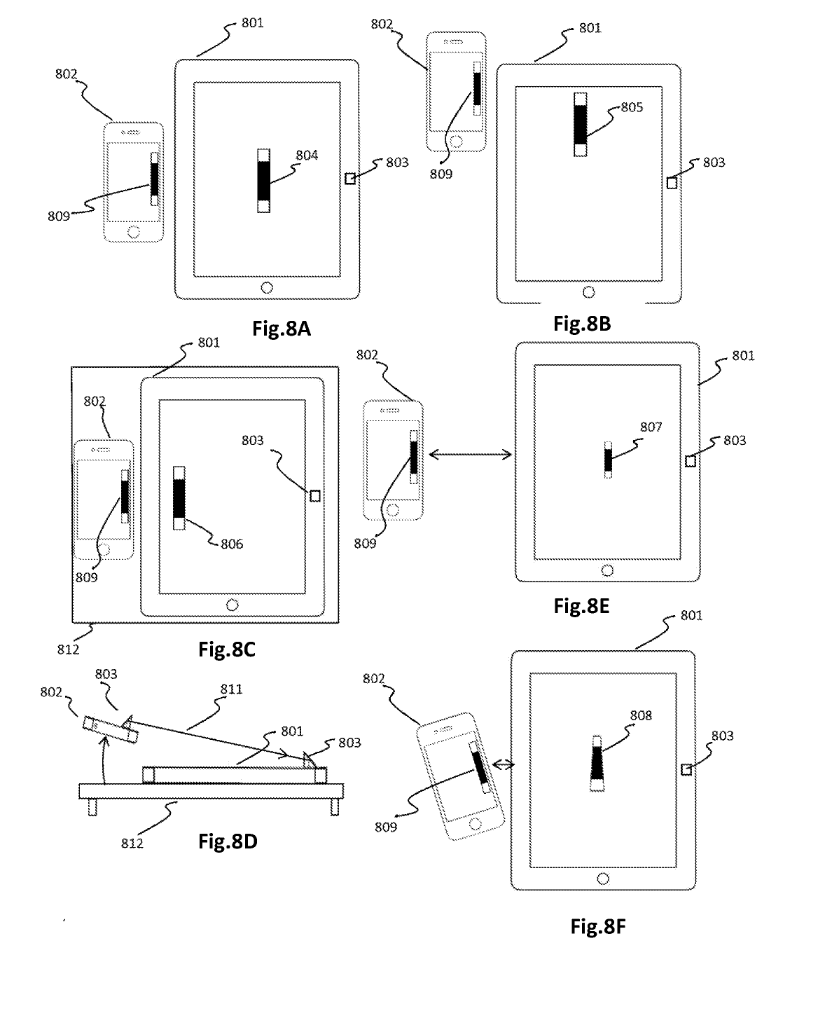

FIG. 8A to 8F illustrate examples of resolvable visual image effects with respect to orientation, relative position and distance viewed from the differing perspectives of interacting nearby smart devices, following broadcast of optical data (via emitter optical structures of FIG. IF) and reception of optical control data through in the FOV afforded by the [camera system input] receptor optical structures of FIG. 1A to 1E For clarity the optical structure which would be positioned to cause redirection of the optical object 804 has been generally omitted in FIG. 8A to 8F, save for FIG. 8E.

By way of illustration, FIG. 8A to 8F shows how an imaged optical object would be viewed on a tablet device 801 with respect to an optical image presented from an emitter optical structure positioned to the edge surface of a smartphone 802. In this case, the optical object corresponds to a uniformly-shaped rectangular bar in which end portions are moderately lightly coloured and in which a central portion is relatively dark. It will be understood that in FIG. 8A to 8D and 8F, any distortion effects caused by the redirection of the optical object image coupled to the emitter optical structure is negligible with respect to the output optical object. In other words, FIG. 8A to 8D and 8F show what the tablet device's camera sees as a coherent output from an output end of the optical emitter structure from each side of the smartphone. Communication flow of control and/or image data is therefore, in this instance, from the smartphone 802 to the camera system on the tablet device 801.

FIG. 8A shows an imaged optical object 804 reproduced on the top face display of tablet device 801. The optical image 809 presented on, i.e. emitted by, the display of smartphone 802 would generally not be visible since it would be beneath the emitter optical structure that provides the re-directing optical structure. If however the optical structure operated by partial internal reflection (e.g. as in the case of a beam splitter) the optical image may be visible through the emitting optical structure and in addition be redirected and output by the emitter optical structure as an optical object. However, for reasons of explanation, the optical image 809 is shown in FIG. 8A to 8D and 8F to show the effects of changing relative position and relative orientation. FIG. 8A shows the situation where the smartphone device 802 is in a central position and close to the edge of tablet device 801. It will be understood that the height and width dimensions of the optical object 809 will decrease according to the increase of physical separation between the optical object and the point of observation; in this case the point of observation is the imaging module or camera of device 801. Other factors influence the relationship between the distance of an object, the point of observation and the perceived dimensions of the object and include but are not limited to such factors as the optical relay elements employed in the emission and reception of the optical object as will be readily understood.

In contrast, FIG. 8B shows the imaged optical object 805 depicted on the top face display of tablet device 801 when smartphone device 802 in positioned in an upper left hand side position but still close to the edge of tablet device 801. In FIG. 8B, the size of the imaged optical object 804 has not significantly changed relative to FIG. 8a, although its position has moved. The top edge of the optical object 804 will in the real world have slightly decreased in length and the bottom edge will have slightly increased in length and has such a minor change has not been illustrated but is understood.

In FIG. 8C shows a plan view of FIG. 8D and is an illustrative example of the imaged optical object 806 is depicted closer to the left hand edge on the top face display of tablet device 801 wherein the separation between the smartphone device 802 camera and tablet device 801 emitter optical structure remains generally similar to that of FIG. 8A. The image 806 is vertically central because the two device are centrally aligned, however as a result of the manipulation of device 802 above the plane of device 802 (refer to FIG. 8D to observe the angular displacement of the smartphone device 802 relative to the tablet device 801). The position of the imaged optical object 806 has translated horizontally to the left, indicating the new position of device 802 elevated above the table 812 on which device 801 is situated.

In FIG. 8E the imaged optical object 807 and depicted smaller, but still central, on the top face display of tablet device 801 because the separation between the imaged optical object 807 smartphone device 802 and receptor optical structure 804 of tablet device 801 has been increased.

In FIG. 8F the imaged optical object 808 depicted on the top face display of tablet device 801 has been distorted in that the rectangular form has been lost. The distortion arises because of relative orientation of the smartphone 802 to the tablet device 801. The imaged optical object 808 remains generally central to the display of tablet device 801 because of central alignment, notwithstanding that the smartphone is inclined and the output array from the emitter optical structure 804 is positioned at an angle of about sixty degree to the vertical. Therefore, one end of the imaged optical object 808 will appear larger than the other end. It is understood the dimension changes of the imaged optical object 808 is due to the difference is separation of some or all points of the imaged optical object 808 with respect to the point of observation i.e. the camera of device 801.

These variations in shape, size and position of the imaged optical object 804-808 permit the local microcontroller to interpret optical object output from the emitter optical structures, and thus to make use of pixel-controlled data on a display on a broadcasting device to provide relative position information in a potentially different plane to that of the display of the device outputting optical object data.

Referring again briefly to FIG. 2A, for exemplary purposes it is pointed out that the device 802 is enabled solely with an emitter optical structure and device 801 is enabled solely with a receptor optical structure. This unidirectional optical communication allows for device 801 to determine at least one of the relative position, distance and orientation of device 802, based on the imaging technique explained in relation to FIG. 8A to 8F, although it will be appreciated that other imaging techniques may be used. Device 801 may communicate its state data including visual display material and data from its on-board sensors and circuitry to device 802 by wireless means including for example Bluetooth® or WiFi and/or by modulation of its emitted optical object. Device 802 may also communicate its state data including visual display material and data from its on-board sensors and circuitry to device 801 by wireless means including for example Bluetooth® or WiFi, but the lack of a secondary optical transmission path via the optical structures of FIG. 1A to IF limits transmission of optically broadcast control information. It will be appreciated that if both devices 801, 802 were enabled with emitter optical structures broadcasting optical objects and receptor optical structures to receive optical objects, either device may determine the relative position of other devices emitting optical objects. There may be two or many devices in this arrangement. At a minimum, at least one device should have an optical structure arranged so as to redirect light from its display screen and, at least one other device should have an optical structure arranged so as to redirect light to its photodetector array or imaging module.

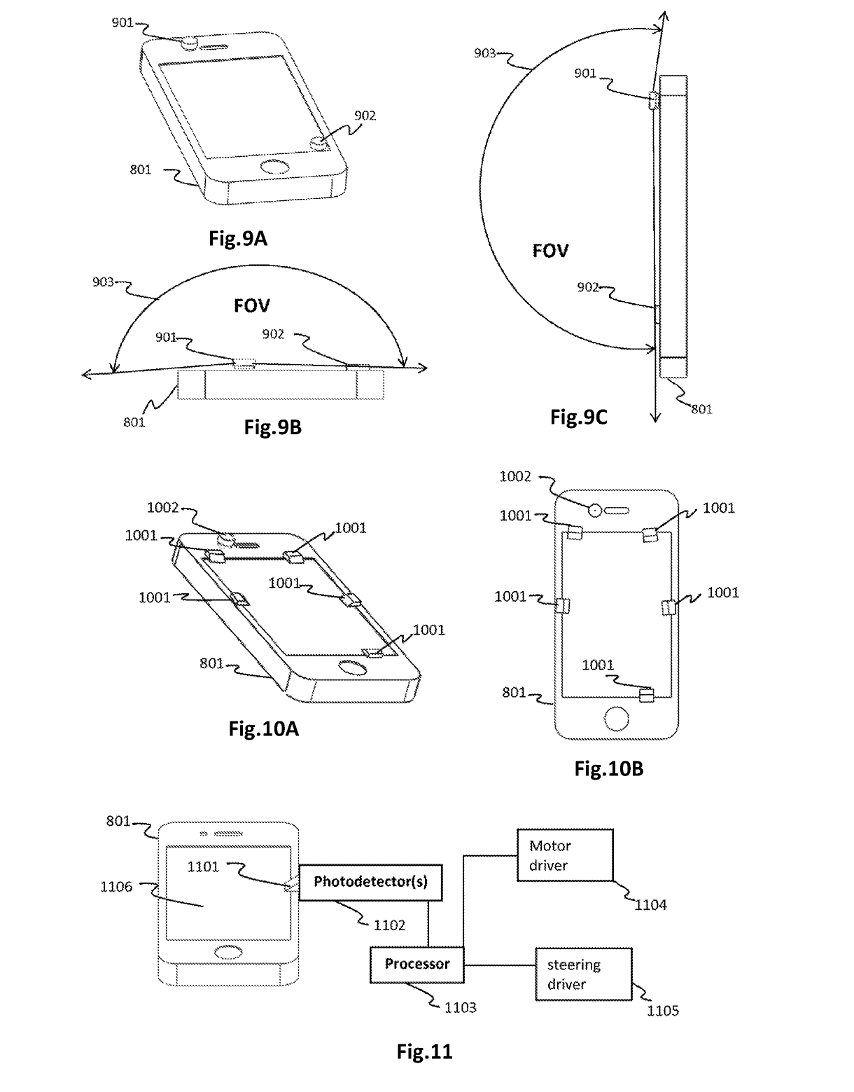

Referring to FIG. 9A to 9C, the FOV 903 of both emitter optical structures 902 and receptor optical structures 901 are determined by their physical placement and optical design, as previously explained FIG. 9A illustrates a use of optical structures that allow the emission and reception of light in a general 360° plane parallel to the display face of the smart device and further extending above to allow a general hemispherical FOV as illustrated by FIG. 9B and FIG. 9C. The FOV available to a smart device enabled with an optical structure depends on the design and placement of the optical structure. The FOV available to a smart device may extend to be almost hemispherical, incorporating a 360° FOV about the coaxial usual axis of the smart device camera and extending to or near to a 90° angle from the plane of the device body. The FOV may be generally hemispherical in field.

FIG. 10A to 10B shows, in accordance with preferred embodiments of the present invention, exemplary positioning arrangements for the preferred optical structures of FIG. 1A to IF as shown in situ on a smart device; other positions are possible as will be understood and depend on smart device design and particularly camera location. It will however be appreciated that the number, positioning and orientation of the emitter optical structures 1001 will be determined by the application in which the smart devices are employed. Optical structure 1002 is positioned to the smart device's front facing camera.

In another preferred embodiment, when one smart device is may be expected to be between two other smart devices as in FIG. 5, a minimal configuration requires the central smart device to have one receptor optical structure and the other two smart devices need only have one emitter optical structure each so that the central smart device is able to determine the positions of the other two smart devices relative to its own body. Supplementary wireless protocols, e.g. the central tablet device may address Bluetooth® transmissions to specific devices, to the left and right positioned smartphone devices and would enable transmission of data to support interactivity. In an alternative preferred arrangement, there may be many emitter optical structures optically coupled about each smart device screen so as to define at least one of each edge or surface or orientation (as shown in FIG. 1F and 2C), and one or more receptor optical structures depending on the number of optical modules or cameras of each smart device.

In yet another preferred embodiment, the optical structure(s) and smart device(s) may be used to enable superior functionality of a range of operational devices or systems including but not limited to simple electromechanical systems enabled solely with simple circuitry or reduced circuitry interfaced to one or more photodetectors e.g. a low cost microprocessor and/or an Analogue to Digital Converter (ADC), a simple transistor circuit, relay etc. to enable a drive capability for a motor or other actuator. Reduced circuitry may include but is not limited to any circuit which may be incapable of enabling the desired functionality with the assistance of a smart device communication and/or control by way of an optical object.

The terms “electronic”, “electromechanical” or “simple” in combination with “system will be understood to mean any structure, system or device enabled with at least one photodetector or sensor capable of at least detecting light and may have an unlimited number of components which may rely on single working principles alone or many in combination for functional operation, e.g. mechanical, optical, electronic, magnetic, electrical, chemical, biological and any other working principles as are known. The term “simple” shall not be construed to limit the complexity of a system but to indicate should the “simple” system be part of a combinatorial system with a smart device, the combinatorial system preferably offers superior functionality and/or more convenient combinatorial system configuration/setup.

In an alternative embodiment the smart device may be located in close proximity to the simple system so as to allow the photodetectors(s) to optically couple to the display screen of the smart device, as shown in FIG. 11. Operationally, in FIG. 11, a program running on the smart device may control the operation of the simple system by modulating the optical object emitted from its screen to communicate control data or transfer data. The aforementioned program may also comprise Artificial Intelligence (AI) software and/or comprise software to perform predetermined operational instructions; such a program(s) may enable the combinatorial system to determine its functional operation independently of external control. An advantage of this arrangement is that the relatively superior processor of the smart device along with its sensors such as accelerometers, magnetometers (compass), inclinometers, GPS, cameras and so on, may be a temporary integral part of the simple system thereby providing superior operation of the combinatorial system. Wireless communications capabilities of the smart device allow for communication of data to, and optionally from, the combinatorial system and in addition provide a means of remote control from another location and from another networked [wireless] device. For example a simple system may consist of a generic model car, comprising a chassis, steering actuator and driver circuit 1105, wheels and a motor and motor driver circuit 1104, photodetector(s) 1102, a power unit such as a battery and a low cost processor 1103. By inserting a smart device 801 into the simple car structure (not shown in FIG. 11) so that the smart device screen selectively optically couples to the simple structure's photodetector(s)1102, the smart device can then run a program and control the simple structures motors and steering by selectively modulating the optical object on its screen. The modulation (which include of colour or intensity or both) is detected by the photodetector(s) 1102 and interpreted by the processor 1103 (or other simple circuitry) which may act purely as a slave circuit to output, in this car example, simple speed and steering signals to the motors drivers 1104 and actuator driver 1105 of the steering mechanism. To highlight the advantage of such an arrangement, the smart device's cameras may capture and communicate live video of the view from the simple car structure to be viewed by another networked or otherwise wirelessly connected device(s) in addition to communication of the smart device sensor outputs. The simple car structure may be remotely controlled wireless by another device(s). The smart device display screen 1106 which had not been occluded by the simple system photodetector(s) and/the optical emitter structure may also provide a local visual output to an observer e.g. a representation of a driver, dashboard, fuel level and so on or otherwise as desired of the application. It will be appreciated that if required the simple system may also be capable of transmitting data to the smart device by modulating a light source e.g. LED(s) under the control of the simple structure's circuitry, the smart device may receive such modulated light via a receptor optical structure according to the embodiments of the instant invention, other input channels of the smart device may also be used e.g. a touch screen, accelerometer or a microphone. The features and methodology described in the ‘car’ example are by way of illustration and other circuits and control methods are readily understood within the art. In certain embodiments an optical structure may be implemented for example as a shutter or as previously described or a lens system of a photodetector wherein at least one purpose of the optical structure is to enable the photodetector(s) to detect the light output from the intended light source such as a pixel(s) of a display screen to resolve the associated communicated data by sufficiently isolating the optical path between the light source and the detector from interference e.g. ambient light or light from pixels of the display not employed deliberately to broadcast the optical object, as will be understood. In another embodiment the instant invention enables simple optical communications to any other device enabled with a camera or phototector(s).

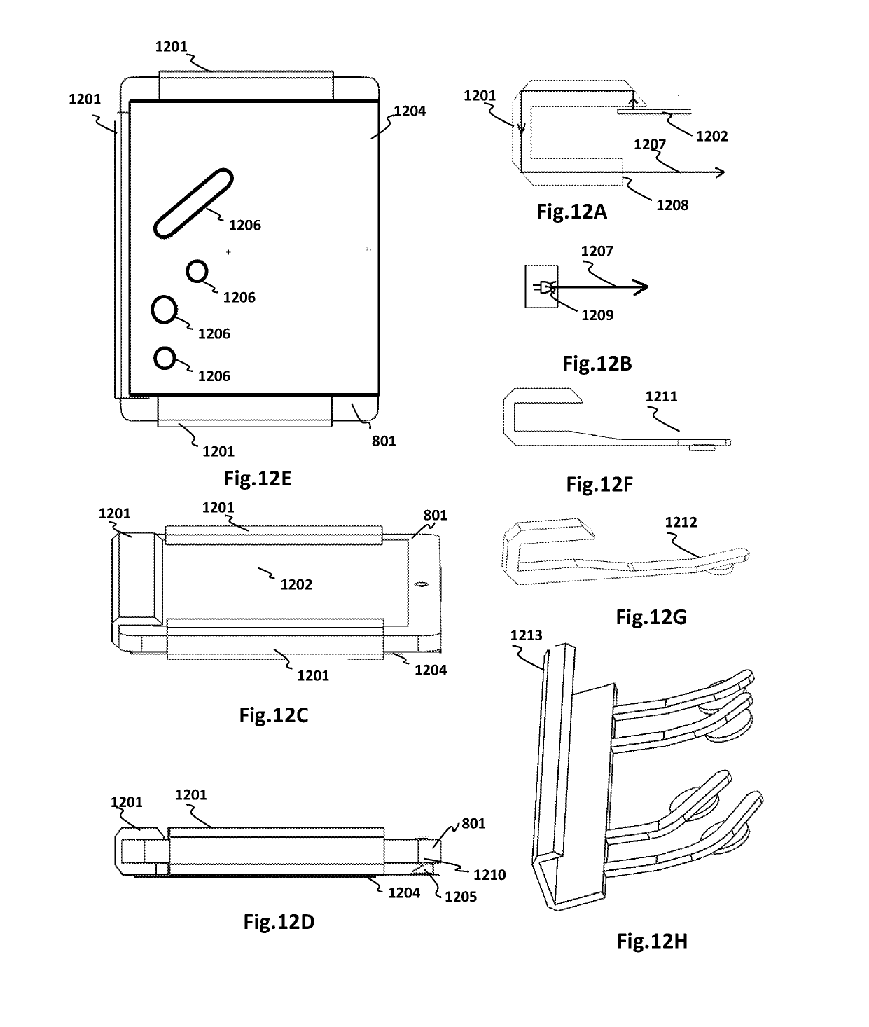

FIG. 12A to 12H illustrates an application of the present invention in the context of a smart device providing means of control input to the same smart device. FIG. 12A shows light emitted by display screen 1202 of a smart device (not shown) redirected by optical emitter 1201 to be directed to a desired direction 1207 so as to be detected by an optical receptor(s) and photodetector(s) assembly (not shown). FIG. 12B illustrates how the light for the display screen may be replaced by an LED to emit light in a desired direction 1207 so as to be detected by an optical receptor(s) and photodetector(s) assembly (not shown). FIG. 12C shows a smart device where three optical emitters 1201 allow light to be redirected from substantially three sides of the display screen of a smart device 801. FIG. 12D shows a side aspects which illustrates the arrangement of the optical emitters 1201, an optical receptor 1205, a camera assembly 1210 normally a component of the smart device 801(not shown in detail) and optionally a backplane 1204 which may provide apertures to act as physical guides to a user's fingers. FIG. 12E shows a rear aspect of the assembly wherein the optional backplane with a number of apertures 1206a,b,c,d which may facilitate finger or other physical shutter insertion to interrupt path of the light emitted by the optical emitter 1201 as received by the optical receptors and photodetector(s) or camera of the smart device 801. FIG. 12F illustrates an embodiment of an optical structure 1211 which may be placed around a smart device so as to guide light from the display of the smart device to be visible by the photodetector of the same smart device by the same principle of the structure 1201. An additional advantage is that the optical structure of FIG. 12F 1211 and FIG. 12G 1212 may be flexed and the resultant position of their optical outputs be detectable by the photodetector of the smart device it is positioned around. The deflection of an optical structure and the subsequent detection of optical output position by the smart devices also are true for any of the optical structures described in the instant invention providing the optical structures were designed to be flexible for the purpose of detectable physical deflection. FIG. 12H illustrates one example of an array of optical structures 1211 arranged to form an array 1213. It is understood that such arrays may be arranged to function as a keyboard may be placed on the rear, front or to the sides of a smart device, depending on the arrangement of the routes of the optical emitter structures so as the optical output from the said optical emitter structures are detectable by optical detector of the same or another smart device or a simple structure as defined in the description of the instant invention.

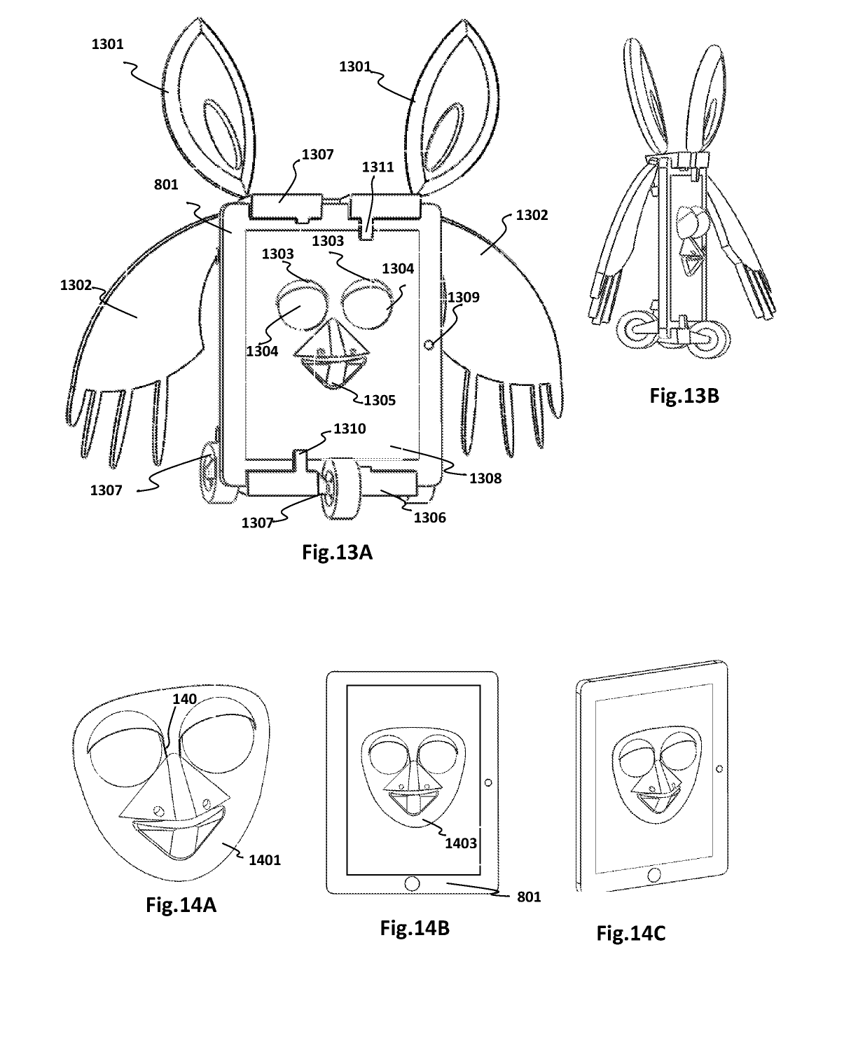

FIG. 13A to 13B illustrates an application of the present invention in the context of a smart device controlling one or more simple systems placed on or about the smart device, and optionally providing display material to augment one or more of the simple systems. Exemplary in FIG. 13A, A fanciful toy bird comprising ears 1301, eyes 1304, eyelids 1303, nose and beak 1305, wings 1302, wheels 1307, a smart device 801, upper display interface and actuator structure 1307 and a lower display interface and actuator structure 1306. Structure 1307 has the integrated functionality of FIG. 11 adapted to enable control of the movement of the wings 1302 and ears 1301 and facilitate communication of control data from the smart device screen1308. Structure 1306 has similar functionality to 1307 but instead enables control the movement of the wheels 1307. A part of structure 1306 and part of structure 1307, namely 1310 and 1311 respectively, overlap the display screen 1308 so as to enable optical coupling to optical emitters which are integrated to 1306 and 1307. Optionally structures 1306 and 1307 may have an integrated light emitter such as an LED which may be modulated and detected by a suitable optical receptor (not shown) and the photodetector(s) or a camera unit 1309 of the smart device 801. FIG. 13B shows a side aspect of FIG. 13A to illustrate the benefit of the embodiment to realise a three dimensional toy with multiple physical moving parts. The eyeball 1304 and eyelid 1303 combination may have actuators and control systems of FIG. 11(not shown) to allow the eye to blink. The nose and beak 1305 may have actuators and control systems of FIG. 11(not shown) to allow 1305 to open and close.

FIG. 14A to 14C illustrates an application of the present invention in the context of a smart device controlling one or more simple systems (assemblies) placed on or about the smart device, and optionally providing display material to augment one or more of the simple systems. Exemplary in FIG. 14A are the eyeballs 1304, eyelids 1303 and nose and beak 1305 assembled on an optically transparent back plate 1401. The eyeball and eyelid combination, which may have actuators and control systems (not shown) to allow the eye to blink, may have data links 1402, which may be optical or electrical, to the nose and beak parts, which may also have actuators and control systems (not shown) to allow the nose and beak to open and close. The back plate 1401 and multiple simple systems mounted on 1401 may share a single optical receptor and photodetector(s) of FIG. 11 adapted to enable control of one or all of the simple systems mounted on back plate 1402. FIG. 14B shows the back plate assembly 1403 of FIG. 14A placed on the screen of smart device 801 so as to be capable of receiving optical data emitted by the display screen of 801. The back plate assembly may be held in a preferred position and orientation by suction cups (not shown), a mechanical mount or other fixative means as will be known. FIG. 14C illustrates how the three dimensional aesthetics benefit of the preferred embodiment of FIG. 14A to 14C.

It is appreciated that the exemplary embodiments of at least FIG. 11, FIG. 13A and FIG. 14A may also include an outer cover or enclosure suitable for the purposes of any or all of; aesthetics, ergonomics or environmental and normal usage protection as required by any specific embodiment or application of the instant invention, as is known in the art.

The smart device may be integrated with the simple system on a temporary basis or for as long a time period as is necessary. The requirement for the simple system to have sophisticated cabled and/or wireless circuitry in order to communicate with a smart device are reduced or deleted totally, are amongst the numerous benefits of communication by way of optical structures coupled to or positioned to the smart device display screen. It will be appreciated there are additional benefits in augmenting the operation of any system which is more complex than the exemplary simple systems described above with the functionality of a smart device by way of optical communication as in the instant invention. The smart device may therefore be another component in any system enabled with at least one photodetector. By use of a camera of the smart device and during either the process of physically engaging the smart device to a system or alternatively when physically fully engaged, a visually recognisable code(s) on the system structure such as a barcode on a label(s) or otherwise printed] or the like may be recognised by the smart device and software “app” suitable for the said system can be initiated to run or downloaded wirelessly to the smart device and initiated to run, thereby providing the combinatorial system a means of self-configuration and start up.

In yet another preferred embodiment a combinatorial system may comprise a smart device and one or more simple systems located directly on or about the smart device wherein the combinatorial system may have the appearance of a toy animal, a cartoon character or any such character realisable by adding one or more simple systems to the smart device. The simple systems may include structures, which may include but is not limited to, actuators to enable movement and which represent eyes; eyelids with lashes, lips, mouth, hands, feet, tail, wings or any such representations as may be desirable. The operation of the simple structures may be perceived by an observer to be alone or in conjunction with the user output of the smart device, for example a simple structure for an eye may comprise an acrylic or other suitable material, hemisphere with an opaque eyelid. An observer views an iris and pupil generated on the smart device screen preferably directly behind the acrylic ‘eyeball’ and the simple system operates to raise and lower the eyelid, it is appreciated that by generating different representations of the iris and pupil on the smart device screen in combination with the physical blinking of the eyelid, many different three dimensional representations can be generated. Likewise feet or wheels or the like may cause the smart device combinatorial toy to move under the programmatic control of the smart device for example to dance. The smart device combinatorial toy will normally operate under programmatic control as enabled by a software application executing on the smart device. The operation of the said toy may also be influenced or controlled by user inputs normally available on the smart device such as touch screen, voice input, remote control means and the like, and may also be influenced by input means as allowed by an such simple systems which form part of the combinatorial system for example a hand simple system which may detect pressure or touch and which may communicate that pressure to the smart device input methods. Intelligent agents or digital assistants such as those on Apple® devices (SIRI) or Google® windows phone (CORTANA) operating on the smart device may provide conversational or informational dialogue with a user. A plush material body sleeve may optionally be used if so desired to enhance the toy appearance.

As in the previously described embodiment of the toy, the combinatorial system may control the delivery or presentation of medicines to individuals. The smart device may control actuators to dispense medicines at appropriate chronological points for the purposes of medicine adherence regimes. Additionally the connectivity of the smart device by cellular or wireless means allows communication of adherence profiles to selected organisations or individuals such as doctors, pharmacists and drug companies. A smart device in such a combinatorial medicine adherence embodiment may provide conversational or informational dialogue with a user about health related questions and topics and may include recording self-reported health or well-being data, such a combinatorial system providing it was so enabled, may also measure, record and communicate physiological measurements, for example heart rate and blood pressure, and human responses to environmental or combinatorial system presented stimuli. Included in the human response measurement and recording are variables such as physiological response to smart device and or to combinatorial system presented stimuli, such stimuli may be audible, visual, haptic or otherwise so as to be potentially understood by the user and a user response potentially elicited and further recorded by the smart device and or combinatorial system.

Any system enabled with at least one photodetector may therefore be improved whilst in combination with part or all of the functionality of a smart device and benefit additionally from a reduced cost to provide the desired functionality. The smart device may be subsequently removed and used for either its original purposes or may be used with other simple systems; each with different intended functionalities. The combinatorial systems described find further applications in wide application fields including but not limited to metrology, instrumentation and utility systems in manufacturing and sciences; control of robotics including at least, Remotely Operated Vehicles (ROV), Unmanned Ariel Vehicles (UAV), pan and tilt enabled CCTV, robotic telescopes, other remote camera and remote control models; system/process control in manufacturing, agriculture and in broad general applications in the fields of education and entertainment including toys, game apparatus, household utility devices e.g. robotic hoovers, lawnmowers, cookers, fridges and personal utility devices such as medical or personal massagers; by the combination of at least minimal electromechanical functionality to address the particular intended task and an enabled smart device providing control and optionally receiving feedback on the task.

The aforementioned combinatorial smart device and “simple system” is also of benefit where a user or operator requires a relatively higher system performance but at a low system cost for any task, of particular benefit for instance where a task which may be carried out infrequently or where combinatorial low cost is attractive including when large numbers of combinatorial systems are required or deployed or may be considered disposable e.g. through accidental damage or loss. Add-on and peripheral devices to traditionally address this requirement are prevalent in both the conventional computer, laptop computer and smart device fields however normally they require an RF wireless interface that normally requires ‘pairing’ or configuration of the device to network with another device on an RF network e.g. Wifi or Bluetooth®, or alternatively wired connection, any of which may incur additional costs and/or inconvenience for the user. The combinatorial system may be used to replace existing devices and systems with traditional add-on or peripherals capable of a wide range of tasks in application fields such as those examples previously described or create devices with a new functionality. It will be appreciated the availability of low cost of smart devices may make this new approach be preferred by many users. If so required servicing of or replacing a faulty component of the combinatorial system is greatly simplified in the case a fault occurs in the intelligent part of the combinatorial system the smart device] whereby the requirement is to merely replace the smart device with another smart device. It will be appreciated replacement may not necessarily be the same model of smart device or indeed have the same operating system as the original, the replacement smart device may be programmed with a downloaded software application to provide the same functionality as the original smart device. The inventor anticipates the aforementioned servicing to be of particular benefit when such replacement is necessary “in the field” including remote geographical areas, allowing a rapid and simple procedure for smart device replacement with another available suitable smart device which may for example just be any available smart device to which an appropriate “app” may be or has been downloaded, The replacement smart device requires at a minimum a processor and a display screen and does not at a minimum require a compatible physical electrical connection or a compatible wireless communication capability or associated wireless protocol such as is understood to be normally found in existing smart device controlled structures. A broad range of applications which benefit from the combinatorial system include at least emergency situations, disaster zones, remote locations, medical or mission critical situations or any military or civilian situations where availability of resources such as experienced/qualified personnel, servicing equipment/tools, spares or time available to perform such necessary servicing of a traditionally integrated system is restricted or limited or where ease of servicing is desirable.

In preferred embodiments the smart device and the simple structures will normally be continually coupled whilst in normal combinatorial operation.

In certain preferred embodiments it will be appreciated that close optical coupling (which may only use air and/or an optical structure(s) to optically couple data encoded light waves to the photodetector) of a smart device's screen to a device enabled with at least on photodetector will enable a communication (which may be a secure communication) between the smart device and a another structure or simple system, the communication being potentially hidden from other observers and free from detection by other commonly used ‘RF sniffing’ techniques. Therefore communication may be enabled in the aforementioned manner of any confidential data such as for example personal details and financial transactions and any data of any type without limitation. A deliberate user input or gesture (but may also be automated by either the user device or receiving device) may initiate the optical communication transaction and may include but not limited to acoustic, touch, button presses, NFC, proximity or any method supported by the interfaces or sensors of the smart device or of the other structure or simple system involved in the communication commonly known in the art. The aforementioned communication apparatus and method may also be applied in the area of keyless locks for example in homes, hotels, secure building, auto vehicles and such where the code to unlock is held securely on a user's smart device and therefore may be shared easily with other authorised users or transferred to a user's other smart device in the case of an upgrade or replacement through faulty operation. It is readily understood that changeable or static key codes may be readily transferred securely to a user's smart device remotely by wireless means or direct means (including an electrical connection) if so required.

In yet another embodiment optical data may be communicated from the screen of a smart device to the imaging module, camera or photodetector(s) of the same smart device. For example a light guide or optical emitter structure may communicate data presented on a smart device's display along a path routed to the back of the smart device and further directed to the smart device's photodetector(s), e.g. a camera. An optical receptor structure such as those already described may be utilised to present the optical signal to an appropriate plane viewable by the smart device's photodetector(s) or camera. The light guide may have a means of interruption such as a physical break in its transmission path which may allow the insertion of a shutter to break the transmission of light to the photodetector(s) or a filter or filter array which can modify the characteristics of the transmitted optical data. Other examples of light path interruption shutter may include but are not limited to solid shutters, shutters with different aperture sizes and/or shapes, variable density filters, colour filter arrays or any of the aforementioned in any achievable combination. The insertion or otherwise movement of the interruption shutter may be brought about by mechanical means such as sliders, spring return buttons, joystick mechanical arrangements, or may even be simple finger holes or slots, wherein the aperture(s) may be as large or as small as desired in order to provide a means of light path interruption. The physical break of the optical waveguide may also allow the alignment of the optical waveguide to be modified, for example the two parts of the light guide may be physically misaligned to interrupt the communicated optical data signal. A physical break is not always required to enable the modification of light being transmitted in a light guide and methods of modification specific to certain light transmitting materials and methods are known in the art including but not limited to deformable (e.g. polymer gel) optical waveguides and waveguides sensitive to close proximity of or contact with another material e.g. magnetic, capacitive, electromagnetics, electrical materials or a person (e.g. a finger). It will be appreciated that the aforementioned waveguides may be routed along any desired path between the smart device display and its photodetector(s) the embodiment may comprise multiple waveguides routed to one or more photodetectors and that data may additionally be programmatically modulated at the display. A software program executing on the smart device may interpret the data received by the photodetector(s) or camera and may be further used as input to the smart device's software applications. One example of the present embodiment as applied to a single smart device is the benefit of enabling a user to input control data to the smart device by modifying or interrupting light transmitted from the display screen of a smart device to the same smart device's camera wherein the optical waveguide is routed along the back, or any other desired surface of the smart device. It will be appreciated that a user may control games and software applications by selectively activating shutters, interrupting optical transmission paths or otherwise modifying optical transmission paths routed about the rear, sides or front face of the smart device by finger touch or gesturing. The current embodiment illustrates how the user benefits by not having to press conventional buttons or finger touch areas on the display and thereby may avoid simultaneously partially occluding the display content where that occlusion is undesirable. It will be appreciated that the routing path(s) for the optical waveguide(s) may be along any path so as to position the waveguide to be effectively interrupted or modified by a user by manual means or another appropriate modification method. The waveguides routing path may be on or about the smart device or may even take any route so desired by a user providing the waveguide can couple to the smart device screen at the input end and emit light at the output end so as to be visible to the smart device's photodetector(s) or camera system and may also have a means of light path interruption as previously described. In a preferred embodiment one of more waveguides may be incorporated in a smart device protective case, front cover or a back shell to allow a user input means that will be communicated software running on the smart device. It will be appreciated that if required, one or more LEDs (Light Emitting Diodes) and a suitable power source may replace or augment the system of optical emitter structures coupled to light emitted from the smart device emissive display.

In yet another preferred embodiment light controlled haptic actuators, which may be in the form of a pillar or bump or other touch discernible feature, hereafter to be referred to as a “bump”, that may be raised above or lowered to be flush with a surface. Exemplary of a Braille embodiment is a panel on which the light activated haptic arrays are arranged so as to be capable of presenting one or more Braille symbol representations. The aforementioned panel may be placed on an emissive display screen and pixels of the screen behind each light controlled haptic actuator selectively modulated and further detected by a photodetector and actuator driver circuitry so as to cause the actuator to raise or lower the bump. The resulting haptic array may present one or more Braille symbols to be discernible by a user's touch. Haptic array actuators may comprise of smart materials actuators such as piezo, photopolymer Nitinol, ferromagnetic, capacitive or electrically activated polymers (EAPs), it is anticipated by the inventor that the photodetector acts as an analogue or digital switch which controls an electrically assisted transform in the actuator. It is also anticipated that each bump actuator have its own photodetector and actuator drive circuitry or alternatively may share portion of that photodetector and actuator drive circuitry with one or more bump actuators on a multiplexed basis, one such example is an multiplexed backplane drive commonly used in flat panel displays or other method commonly known in the art.

### Applications of Relative Position Aware Smart Devices

The instant invention may be used in areas in addition to those already described where the arrangement of one or more smart devices, the visual display material (including discrete objects) presented on each smart device and their relative positions and orientations are designed to support contextually meaningful multi-device interaction. Example applications include, but are not limited to:
gaming, one example as described in FIG. 5 although two or many devices may be involved and as will be understood, the devices may not always be on the same planar surface such as a table. The physical space which bounds the relative positions of the smart devices whilst engaged in an interactive activity is determined by the FOV of the receptor optical structures and the field of emission of the emitter optical structures, as is the case for any of the interactive applications of the instant invention, as will be appreciated.
in education and teaching of any subject including those involving construction and deconstruction of parts where positioning is meaningful, e.g. literacy and languages, numeracy and sums, musical composition, science including physics, chemistry and biology
entertainment, such as card games, board games and such activities where elements represented on smart devices' displays move relative to each other and are able to bring about an effect or interaction resulting in a change in state of any one or more than one of the interacting devices
embodiments of the present invention have applications where a smart device may be surrounded by a board, or placed onto a board, on which is printed landscapes or other graphics contextual to the activity. In this instance, other smart devices may be moved around the board and/or moved around the board relative to other smart devices on the board, the graphics on the board may provide additional visual feedback to the users of the smart devices and each smart device generate meaningful interactions based on the relative positions of the smart devices and their time varying state in context of the activity and/or positioning on the board. Rear facing cameras of each smart device may capture position and/or identifying registration information embedded in the printed material of the board. The board surface may also be a display screen to allow the background to be changeable in accordance with the desired activity. The board surface is not limited to being planar and it will be appreciated may be any shape as required by the activity.
smart devices may be incorporated into plush toys and provision made for the optical FOV necessary for relative position interactivity between two or more smart devices e.g. by way of apertures in the plush toy body or by adaptation of the optical structures to project through the plush toy body, or by some or all of sections of the plush toy designed to be transparent to the light transmitted and received by the enabled smart devices therein incorporated. It will be appreciated that plush toys exemplar of such embodiments and any suitable toy structure, structures intended for entertainment and/or education may be equally suitable for adaptation with the instant invention.

In other embodiments, the optical structures may be used to enable sophisticated control of robotics assemblies or simple structures enabled solely with a reduced computational capacity microprocessor and circuitry, e.g. a low cost microprocessor interfaced to one or more photodetectors. Other applications enable simple optical communications to another device as enabled by a camera or phototector(s).

The smart device may be located in close proximity to the simple structure so as to allow the photodetectors(s) to optically couple to the display screen of the smart device, as shown in FIG. 11. Operationally, in FIG. 11, a program running on the smart device may control the operation of the simple structure by modulating the optical object emitted from its screen to communicate control data or transfer data. An advantage of this arrangement is that the relatively superior processor of the smart device along with its sensor outputs such as accelerometers, magnetometers, inclinometers, cameras and so on, may be used as an integral part of the simple assembly, providing superior operation of the simple structure. Wireless communications capabilities of the smart device allow for communication of data to and from the simple structure in addition to providing a means of remote control from another location and another wireless device. For example a simple structure may consist of a generic model car, comprising a chassis, steering actuator and driver circuit 1105, wheels and a motor and motor driver circuit 1104, photodetector(s) 1102, a power unit such as a battery and a low cost processor 1103. By inserting a smart device 801 into the simple car structure (not shown in FIG. 11) so that the smart device screen optically couples to the simple structure's photodetector(s)1102, the smart device can then run a program and control the simple structures motors and steering by modulating the optical object on its screen. The modulation is detected by the photodetector(s) 1102 and interpreted by the simple structure processor 1103 which may act purely as a slave communications unit to output simple speed and steering signals to the motors drivers 1104 and actuator driver 1105 of the steering mechanism. To highlight the advantage of such an arrangement, in addition to communication of the smart device sensor outputs, the smart device's cameras may also capture and communicate live footage of the view from the simple car structure to be viewed by another connected wireless device(s). The simple car structure may be remotely controlled wireless by another device(s). The smart device display screen 1106 which had not been occluded by the simple structure photodetector(s) may also provide a local visual output to an observer of for example a representation of a driver, dashboard, fuel level and so on.

It will be appreciated that any electromechanical or electronic system which a user desires a sophisticated performance of, yet which system is enabled only with a low cost or basic processor capability would benefit substantially from the integration with a smart device and optical object communication apparatus according to the embodiments of the optical data transfer and optical control system as described above. The smart device need only be integrated with the simple structure on a temporary basis or as is necessary. The benefit of communication by way of optical structures coupled to the smart device display screen is that the requirement for the simple structure to have sophisticated cabled or wireless circuitry in order to communicate with a smart device is reduced or deleted totally.

To provide for interaction with a user, the state of a smart device may be changed in any manner supported by the smart device's integrated sensors, devices and/or circuits or externally attached peripherals or any wirelessly connected peripherals or by way of any device networked or otherwise wirelessly connected. The input means or means of interaction may include but are not limited to manual manipulation of the device or any connected devices; touch on a touch screen, voice control, camera detectable gestures, and acoustic input from other users or devices. The smart device state may provide feedback to a user in any manner supported by the smart device's integrated or externally attached peripherals or any wireless connected peripherals or by way of any device networked or otherwise wirelessly connected. User feedback may be visual, auditory, haptic or tactile. Examples of communication networks include Wide Area Network (WAN) e.g. the internet and Local Area Network (LAN).

Smart devices 801 and 802 may communicate over any wireless communications technologies, protocols and networks by which they are individually enabled. Examples of wireless and ‘localised air-interface’ communications technologies and related protocols include but are not limited to for example Bluetooth®, Wifi, WiMax, 802.11 protocols, Infra-red such as IRDA, Near Field Communications (NFC) protocols and cellular networks such as GPRS, EDGE or GSM networks

It will be understood that smart devices 801 and smart device 802 are merely exemplary of smart devices in general and smart devices 801 and 802 may be interchangeable without limit in respect of any representations in the Fig.s or drawings of the instant application. Details of the graphical drawings of 801 and 802 are for purposes of illustration only and the position of cameras, screens etc. may vary between Fig. s as required for illustration.

Unless specific arrangements are mutually exclusive with one another, the various embodiments described herein can be combined to enhance system functionality and/or to produce complementary functions that improve data transfer techniques and adjacent surface identification. Indeed, it will be understood that unless features in the particular preferred embodiments are expressly identified as incompatible with one another or the surrounding context implies that they are mutually exclusive and not readily combinable in a complementary and/or supportive sense, the totality of this disclosure contemplates and envisions that specific features of those complementary embodiments can be selectively combined to provide one or more comprehensive, but slightly different, technical solutions. It will, of course, be appreciated that the above description has been given by way of example only and that modifications in detail may be made within the scope of the present invention.

1) A processor-controlled first device;
comprising a display screen, said display screen further configured under processor control to;
selectively emit light from one or more pixels of the said display screen and;
broadcast said emitted light to be coupled to the input of at least one optical structure and;
wherein the optical signal output of said at least one optical structure being detectable by at least one photodetector of at least one device adapted to resolve the detected optical signal.

2) An apparatus of claim 1 whereby said at least one device adapted to resolve the detected optical signal is enabled with at least one photodetector and at least one optical structure.

3) An apparatus of claim 1 whereby the optical signal output is detectable by at least one device adapted to resolve the detected optical signal device, which may also be a second device and is enabled with at least one photodetector.

4) An apparatus of claim 1 wherein at least one device adapted to resolve the detected optical signal and may also be a second device, may determine the relative position of a first device.

5) An apparatus of claim 1 wherein at least one device adapted to resolve the detected optical signal and may also be a second device, may determine the relative orientation of a first device.

6) An apparatus of claim 1 wherein a first device may communicate data to a wherein at least one device adapted to resolve the detected optical signal and may also be a second device.

7) An apparatus of claim 1 wherein a first device may communicate state data to at least one device adapted to resolve the state data and may also be a second device

8) An apparatus of claim 1 wherein a first device may optically broadcast an optical object comprising of at least one of i) a fixed light pattern or ii) a changeable light pattern.

9) An apparatus of claim 1 wherein a first device may communicate control data to a simple system enabled with at least one photodetector.

10) An apparatus of claim 1 wherein the optical structure may be deflected by a mechanical pressure resulting in a physical position change of the output end of the optical structure.

11) An apparatus of claim 1 wherein optical path between the optical structure and the photodetector allows the optical signal to be modified or occluded by the insertion of shutter.

12) A method of a first device to establish communication with a second device having first identified a second device by its relative position based on the second device's optically broadcast communication.

13) A method of claim 12 wherein a first device may establish a Radio Frequency selective communication with a second device based on at least one of the selected second device's 1) IP address, 2) assigned address 3) unique RF identity (ID).

14) A method of claim 12 wherein a first device may establish a selective communication with a second device for the purposes of coordinating interactions between the first and second devices based on their determined relative positions.

15) A method of claim 12 wherein a first device may establish a selective communication with a second device for the purpose of coordinating interactions between the first and second devices based on their determined relative orientations.

16) A method of claim 12 wherein a first device may establish a selective communication with a second device for the purpose of coordinating interactions between the first and second devices based on the determination of relative orientations of displayed objects on their respective display screens.

17) A method of claim 12 wherein a first device may establish a selective communication with a second device to establish a network of relative position aware devices.

18) A method of any preceding claim wherein the number of smart devices is more than two.
